(19) United States
(12) Patent Application Publication
(10) Pub. No.: US 2017/0003314 A1
(43) Pub. Date: Jan. 5, 2017

(54) Z-AXIS PHYSICAL PROXIMITY SWITCH

(71) Applicant: Lumedyne Technologies Incorporated, San Diego, CA (US)

(72) Inventors: Richard Lee Waters, San Diego, CA (US); Charles Harold Tally, IV, Carlsbad, CA (US); Xiaojun Huang, San Diego, CA (US); John David Jacobs, San Diego, CA (US); Yanting Zhang, San Diego, CA (US); Mark Steven Fralick, San Diego, CA (US)

(21) Appl. No.: 15/198,924

(22) Filed: Jun. 30, 2016

Related U.S. Application Data
(60) Provisional application No. 62/186,655, filed on Jun. 30, 2015.

(51) Int. Cl. G01P 15/125

(52) U.S. Cl. CPC G01P 15/125

(57) ABSTRACT

Sensors and systems are described herein for out-of-plane sensing. In particular, the sensors and systems relate to vibratory inertial sensors implementing time-domain sensing techniques with linear combinations of multiple signals. In out-of-plane sensing, these multiple signals may be produced from a single sense mass oscillation. Time intervals produced from linear combinations of these multiple signals can be used to measure inertial parameters, such as acceleration, and other values of interest.

### CROSS REFERENCE TO RELATED APPLICATIONS

This application claims priority to U.S. Provisional Application Ser. No. 62/186,655 filed on Jun. 30, 2015, the entire contents of which are hereby incorporated by reference.

### FIELD OF THE INVENTION

This invention relates to sensing out-of-plane displacements, particularly in inertial sensors and gyroscopes used to detect acceleration and rotation.

### BACKGROUND OF THE INVENTION

Existing out-of-plane displacement sensors may implement differential sensing, whereby multiple signals are linearly combined to remove noise present in each signal. For out-of-plane displacements, this often means that sense structures are designed such that as one capacitive gap becomes smaller in the z-direction, another gap will become larger in the z-direction. When calculating displacement and inertial parameters from capacitance, conventional sensors rely on a relationship between displacement and capacitance defined by fixed offsets and scale factors. This relation is often linear. However, particularly for large displacements, changes in capacitance are non-linear, and environmental factors lead to long-term drift in fixed conversion factors between displacement and capacitance, both of which degrade the overall accuracy of the sensor.

### SUMMARY OF THE INVENTION

Accordingly, an out-of-plane sensor and a system for out-of-plane sensing are described herein. An out-of-plane sensor can comprise a sense mass coupled to an in-plane support structure, where the sense mass is configured to oscillate out-of-plane with respect to an in-plane support structure. A time domain switch can be coupled to the sense mass. The time domain switch can comprise a first electrode at a first radial distance of the sense mass, and can produce a first signal. The time domain switch can comprise a second electrode at a second radial distance of the sense mass and can produce a second signal. A processor can be in signal communication with the time domain switch can be configured to detect time intervals from a linear combination of the first signal and the second signal.

In some examples, the sense mass can oscillate out-of-plane in rotation about an axis in a plane of the in-plane support structure. In some examples, the first radial distance is larger than the second radial distance, the first electrode has a first area, and the second electrode has a second area, wherein the first area can be larger than the second area. In some examples, the linear combination of the first signal and the second signal is a differential in capacitance. In some examples, the time intervals are based in part on times at which the differential in capacitance is equal to zero. Some examples further include determining an acceleration of the in-plane support structure based on the time intervals.

In some examples, the first electrode is vertically offset upward from the sense mass. In some examples, the second electrode is vertically offset downward from the sense mass. In some examples, a portion of the sense mass and the second electrode are etched to the same height. In some examples, the sense mass oscillates by raising and lowering linearly along an axis perpendicular to the in-plane support structure. In some examples, the first radial distance is larger than the second radial distance, and the area of the first electrode is equal to the area of the second electrode. In some examples, the time intervals are a first set of time intervals based on zero-crossings of a time derivative of the first signal, and a second set of time intervals based on zero-crossings of a time derivative of the second signal. In some examples, the time intervals of the first set and the second set do not include points of zero velocity. Some examples further include determining an acceleration of the in-plane support structure based on the time intervals.

A system for out-of-plane sensing described herein can comprise a sense mass coupled to an in-plan support structure, where the sense mass is configured to oscillate out-of-plane with respect to an in-plane support structure. A time domain switch can be coupled to the sense mass. The time domain switch can comprise a first electrode at a first radial distance of the sense mass, and can produce a first signal. The time domain switch can comprise a second electrode at a second radial distance of the sense mass and can produce a second signal. A processor can be in signal communication with the time domain switch can be configured to detect time intervals from a linear combination of the first signal and the second signal.

In some examples, the sense mass can oscillate out-of-plane in rotation about an axis in a plane of the in-plane support structure. In some examples, the first radial distance is larger than the second radial distance, the first electrode has a first area, and the second electrode has a second area, wherein the first area can be larger than the second area. In some examples, the linear combination of the first signal and the second signal is a differential in capacitance. In some examples, the time intervals are based in part on times at which the differential in capacitance is equal to zero. Some examples further include determining an acceleration of the in-plane support structure based on the time intervals.

In some examples, the first electrode is vertically offset upward from the sense mass. In some examples, the second electrode is vertically offset downward from the sense mass. In some examples, a portion of the sense mass and the second electrode are etched to the same height. In some examples, the sense mass oscillates by raising and lowering linearly along an axis perpendicular to the in-plane support structure. In some examples, the first radial distance is larger than the second radial distance, and wherein the area of the first electrode is equal to the area of the second electrode. In some examples, the time intervals are a first set of time intervals based on zero-crossings of a time derivative of the first signal, and a second set of time intervals based on zero-crossings of a time derivative of the second signal. In some examples, the time intervals of the first set and the second set do not include points of zero velocity. Some examples further include determining an acceleration of the in-plane support structure based on the time intervals.

### BRIEF DESCRIPTION OF THE DRAWINGS

Further features of the invention, its nature and various advantages will be apparent upon consideration of the following detailed description, taken in conjunction with the accompanying drawings, in which like reference characters refer to like parts throughout, and in which:

FIG. 1 depicts a periodic capacitive structure used to produce a nonlinear periodic signal in response to out-of-plane displacements, according to an illustrative implementation of the present invention;

FIG. 2 depicts three cross views of a vertical sense structure for measuring out-of-plane displacements, according to an illustrative implementation;

FIG. 3 depicts three cross views of a second vertical sense structure for measuring out-of-plane displacements, according to an illustrative implementation;

FIG. 4 depicts a perspective view of an inertial device that may be used to measure out-of-plane displacements, according to an illustrative implementation;

FIG. 5 depicts eight configurations of fixed and moveable beams which may be used to sense out-of-plane displacements, according to an illustrative implementation;

FIG. 6 is a schematic of a process used to extract inertial information from an inertial sensor with out-of-plane sensing, according to an illustrative implementation;

FIG. 7 is a graph representing the relationship between analog signals derived from an out-of-plane sensor and the displacement of a moveable element of the sensor, according to an illustrative implementation;

FIG. 8 is a graph showing time intervals produced from crossings of non-zero reference levels by the displacement of a moveable element of an out-of-plane sensor, according to an illustrative implementation;

FIG. 9 is a graph illustrating the current response to the displacement of a moveable element of an out-of-plane sensor, according to an illustrative implementation;

FIG. 10 is a graph showing a rectangular-wave signal produced from zero-crossing times of the current signal depicted in FIG. 9, according to an illustrative implementation;

FIG. 11 is a graph showing the effects of an external perturbation on the output signal of an out-of-plane sensor, according to an illustrative implementation;

FIG. 12 is a graph depicting capacitance as a function of the displacement of a moveable element of an out-of-plane sensor, according to an illustrative implementation;

FIG. 13 is a graph depicting the first spatial derivative of capacitance as a function of the displacement of a moveable element of an out-of-plane sensor, according to an illustrative implementation;

FIG. 14 is a graph depicting the second spatial derivative of capacitance as a function of the displacement of a moveable element of an out-of-plane sensor, according to an illustrative implementation;

FIG. 15 is a graph depicting the time derivative of the capacitive current as a function of the displacement of a moveable element of an out-of-plane sensor, according to an illustrative implementation;

FIG. 16 is a graph representing the position of a moveable element of an out-of-plane sensor relative to time, according to an illustrative implementation;

FIG. 17 is a graph representing the velocity of a moveable element of an out-of-plane sensor relative to time, according to an illustrative implementation;

FIG. 18 is a graph representing acceleration of a moveable element of an out-of-plane sensor relative to time, according to an illustrative implementation;

FIG. 19 is a graph representing two capacitive signals produced by an out-of-plane sensor relative to the displacement of a moveable element of the out-of-plane sensor, according to an illustrative implementation;

FIG. 20 is a graph representing capacitance relative to angular position of the moveable element of an out-of-plane sensor, according to an illustrative implementation;

FIG. 21 is a graph representing capacitive slope relative to angular position of a moveable element of an out-of-plane sensor, according to an illustrative implementation;

FIG. 22 is a graph representing capacitive curvature relative to angular position of a moveable element of an out-of-plane sensor, according to an illustrative implementation;

FIG. 23 is a graph representing capacitance relative to time and produced in response to oscillations of a moveable element of an out-of-plane sensor, according to an illustrative implementation;

FIG. 24 is a graph representing capacitive slope relative to time and produced in response to oscillation of a moveable element of an out-of-plane sensor, according to an illustrative implementation;

FIG. 25 is a graph representing capacitive curvature relative to time and produced in response to oscillations of a moveable element of an out-of-plane sensor, according to an illustrative implementation;

FIG. 26 is a graph representing differential capacitance relative to time and produced in response to oscillations of a moveable element of an out-of-plane sensor, according to an illustrative implementation;

FIG. 27 is a graph representing differential capacitive slope relative to time and produced in response to oscillations of a moveable element of an out-of-plane sensor, according to an illustrative implementation;

FIG. 28 is a graph representing differential capacitive curvature relative to time and produced in response to oscillations of a moveable element of an out-of-plane sensor, according to an illustrative implementation;

FIG. 29 is a graph representing capacitance relative to the position of a moveable element of a second out-of-plane sensor, according to an illustrative implementation;

FIG. 30 is a graph representing capacitive slope relative to the position of a moveable element of a second out-of-plane sensor, according to an illustrative implementation;

FIG. 31 is a graph representing capacitive curvature relative to the position of a moveable element of a second out-of-plane sensor, according to an illustrative implementation;

FIG. 32 is a graph representing capacitance relative to time and produced in response to oscillations of a moveable element of an second out-of-plane sensor, according to an illustrative implementation;

FIG. 33 is a graph representing capacitive slope relative to time and produced in response to oscillations of a moveable element of a second out-of-plane sensor, according to an illustrative implementation; and

FIG. 34 is a graph representing capacitive curvature relative to time and produced in response to oscillations of a moveable element of a second out-of-plane sensor, according to an illustrative implementation.

### DETAILED DESCRIPTION

To provide an overall understanding of the disclosure, certain illustrative implementations will now be described, including systems and methods for measuring out-of-plane displacements of a sensor.

Out-of-plane sensing uses the monitored motion of a sense structure to detect a number of parameters of interest. In out-of-plane sensing, a moveable element, which may be a sense mass, may move in response to forces that have a component in the dimension perpendicular to the plane of the sensor. For example, in a sensor that is in the x-y plane, an out-of-plane sensor would detect forces with a component in the z-axis. In the specific case of vibratory sensors, the sense structure may physically oscillate in periodic motion at equilibrium. Outside forces cause perturbations to this oscillation, which may be detectable in an analog electrical signal produced from the sense mass physical motion as a result of electro-mechanical sensing. By monitoring the motion of the sense mass, one can determine resonant frequency, resonant amplitude, temperature, and inertial forces such as acceleration, rotation, pressure, acoustic waves, etc.

Many out-of-plane sensors are “fixed” sensors, meaning that they use fixed scale factors and fixed offsets to define a relationship between an output signal and the moveable element's out-of-plane displacement. In fixed linear sensors, a fixed scale factor with a fixed offset is used to approximate a linear relationship between the output and displacement. However, both the scale factor and the offset of a sensor can change over time due to environmental and electrical factors, including: changes in temperature, long-term mechanical creep, changes in packaging pressure of the sensor due to imperfect seals or internal outgassing, changes in the quality factors of the resonator, drift in one or more amplifier gain stages, capacitive charging effects, drift in bias voltages applied to the sensor, drift in any internal voltage reference required in a signal path, drift of input offset voltages, drift of any required demodulation phase and gain, etc. In “fixed” sensors, changes in the scale factor or the offset may result in the false detection of an external perturbation, or an inaccurate measurement. These changes cause the accuracy of a sensor to degrade over time. Because the scale factors produce systematic errors, often “fixed” sensors require manual re-calibration—a solution that is not always practical or available.

The environmental factors that produce changes in the fixed scale factors or fixed offsets that affect fixed sensors may also reduce the accuracy of a sensor in other designs, albeit in different ways than affecting fixed values. Even in sensors without a fixed relationship between the output signal and displacement, environmental factors may result in common mode noise, which is a form of coherent interference where noise exists equally and in phase on multiple signal paths, and is therefore not easily distinguished or isolated from the desired signal information, since in many cases combining signal paths together will simply compound or amplify the noise. Examples of common mode noise are the same factors that may affect the fixed scale factor or offset, and include temperature changes, long-term mechanical creep, environmental vibrations, packaging deformations, parasitic capacitance, drift in bias voltages, drift in any internal voltage references, ground loops, and other environmental or electrical noise sources that result in systematic errors.

One way to reduce the affects of these noise sources is to employ sensing techniques that produce multiple signals as a result of a single motion in such a way that the linear combination of signals will in fact remove or detect the systematic noise present in both signals. One of these techniques is “differential sensing,” where computing the difference between two signals results in the elimination of common mode noise present in both signals. Differential sensing may also take the form of measuring values across these multiple signals, to produce relative measurements between them. In linear, out-of-plane sensing systems, differential sensing is typically accomplished by sensing architectures that increase a first gap while simultaneously decreasing a second gap in response to perturbations, and capacitively sensing across the two gap distances to get two, differential capacitive signals. While this may reduce the affects of drift in scale factors and bias offset of linear sensors, it does not address the issues inherent to linearizing a non-linear signal.

In addition to the problems associated with fixed scale factors and offsets that may drift over time, using linear sensing in vibratory sensors suffers from the inaccuracies inherent in linearizing what is in fact non-linear motion and signal response. Oscillations of sense structures of vibratory sensors undergo sinusoidal, periodic motion. While these displacement curves can be locally approximated as linear, they do not have true linear motion or responses to outside perturbations. Even in non-vibratory linear sensors, the physical response of the sense mass is not pure linear motion, due to inertial affects, damping, etc. This is particularly the case for large displacements of the sense mass, in which the locally linear approximation breaks down over a larger segment of the amplitude response curve. The output signal produced by motions of the sense mass, whether capacitively sensed or through another electromechanical means, is therefore also non-linear.

By employing non-linear out-of-plane differential sensing of a sense mass motion, one may thus simultaneously eliminate the inaccuracies produced by common mode noise and by linear capacitive sensing. Non-linear sensing determines parameters through non-linear signals produced by the sense mass. In the context of time-domain-switch (“TDS”) sensing, the differential signal produced may be converted to time intervals that are used to calculate the desired output of the out-of-plane sensor, which may include resonant frequency and amplitude, temperature and inertial forces such as acceleration, rotation, pressure/acoustic waves, etc. Furthermore, in TDS sensing, one may link these time intervals to known physical locations of a sense mass through the geometric design of the TDS structure. This connection between time intervals and known physical locations may allow for the real-time monitoring of changes to the sensor's offset and other constants that may vary in response to environmental factors.

Non-linear periodic signals also contain significantly more information than linear signals do, and enable independent measurement of multiple system variables from a single signal. By measuring each parameter of interest independently, it is possible to decouple the measurements from other factors that may affect the system output. For example, an oscillating mechanical system that produces a non-linear periodic output signal can enable independent measurements of oscillator amplitude, oscillator resonant frequency, offset of the oscillator (which may be related to acceleration), velocity (from the first time derivative of displacement), jerk (from the first time derivative of acceleration) and temperature of the system (via a measurement of the oscillator's resonant frequency). In contrast, a linear system has fewer time derivatives, and the fixed offset and scale factors mask information present in a non-linear periodic signal.

The out-of-plane differential sensing may be a component of a MEMS sensor, and designed such that the time intervals produced by a TDS sensor are tied directly to the fabrication process and mask geometries of the sensor, creating stable reference points for determining the MEMS sense mass position over time.

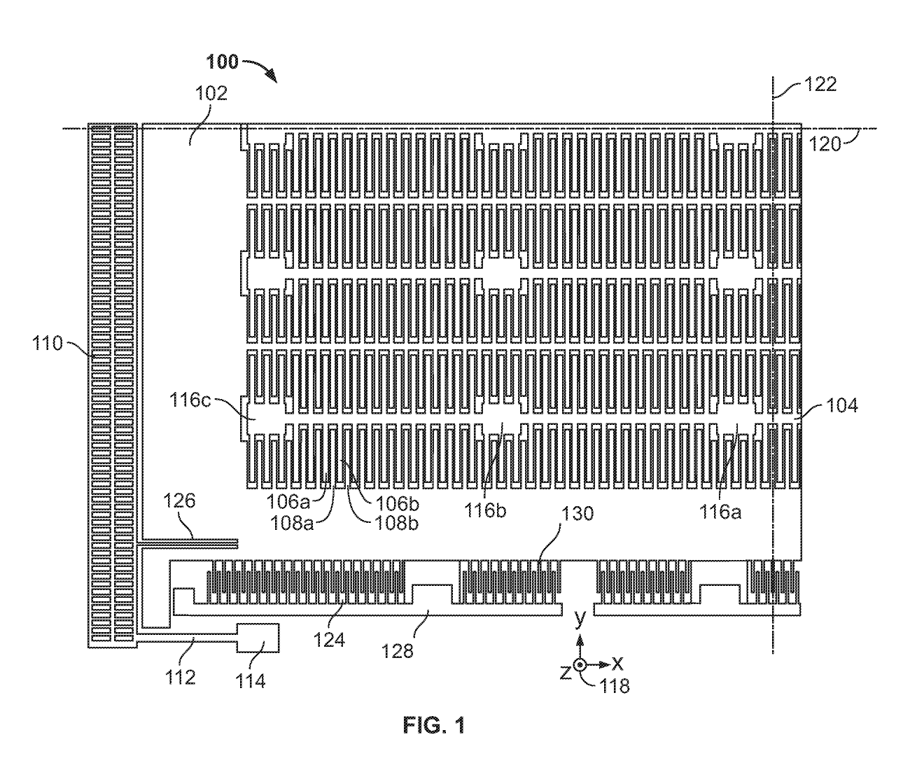

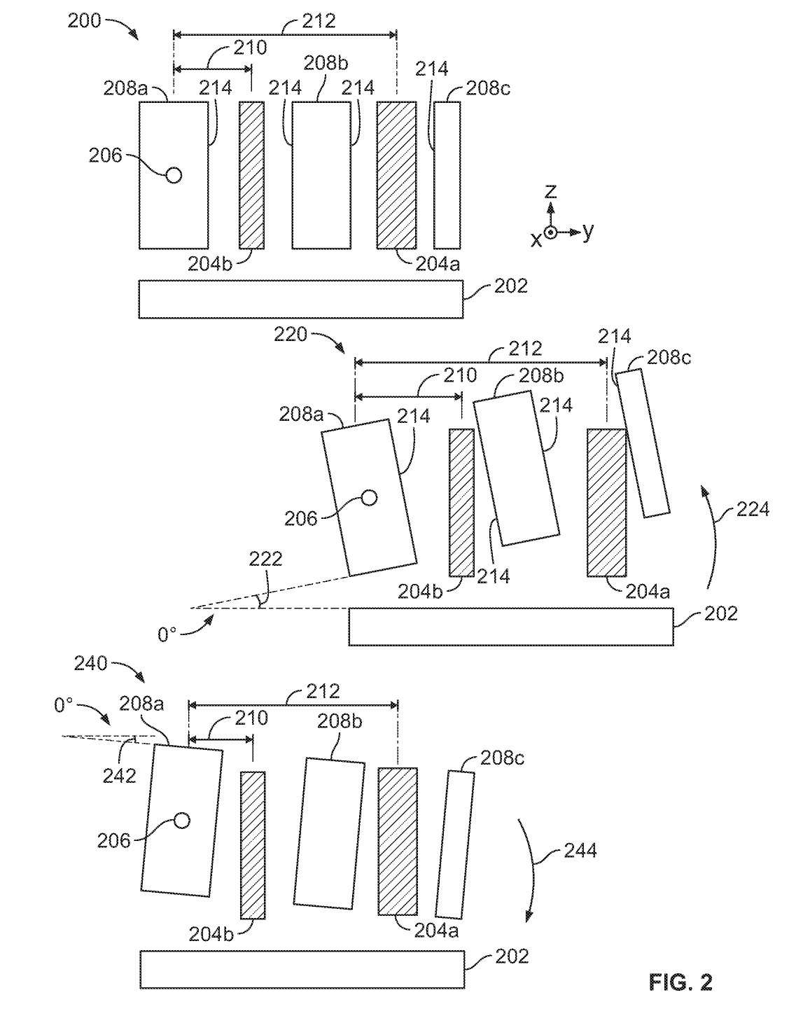

FIG. 1 depicts a periodic capacitive structure used to produce a nonlinear periodic signal in response to out-of-plane displacements, according to an illustrative implementation of the present invention. The out-of-plane sensor 100 includes a moveable element 102, a fixed element 104, a comb drive 124, and a spring element 126. The moveable element 102 includes beam 108a and 108b (collectively, beams 108). The fixed element 104 includes beams 106a and 106b (collectively, beams 106). Beams 106 and 108 are interdigitated as shown. The moveable element 102 and the fixed element 104 can include additional beams, or beams with different periodic geometry than shown in FIG. 1, such as the periodic geometry described in further detail with reference to FIGS. 2-5. The fixed element 104 is rigidly fixed to the body of the sensor such that it experiences the same external perturbations as the sensor. The moveable element 102 is compliant in the z direction, as indicated at 118, and is coupled to the fixed element 104 by a spring elements 112 and 126.

The moveable element 102 may oscillate in periodic motion in the z direction, moving vertically with respect to the fixed element 104 as indicated by the axis 118. This vertical oscillation may be linear translation in the z-axis, rotational oscillation about an axis in the x-y plane, or any other vertical oscillation that is substantially in the out-of-plane dimension of the sensor. As can be appreciated, the out-of-plane sensor 100 may be rotated into a different orientation than that shown by the axis 118. The spring elements 112 and 126 may be substantially compliant only in the z direction, such that motion of the moveable element 102 in the x or y directions is restricted. Oscillation of the moveable element 102 in the z direction may be accomplished via a comb drive 124. In some examples, the comb drive 124 actuates the moveable element 102 at a resonant frequency of the structure 100. In some examples, the comb drive 124 actuates the moveable element 102 at a frequency that is different than the resonant frequency of the structure 100. Oscillating structure 100 at its resonant frequency may reduce the power usage of the comb drive 124, since oscillations at the resonant frequency will effectively amplify the displacement of the moveable element 102.

The resonant frequency of structure 100 will be defined by the mass of the moveable structure 102 and the stiffness, or spring constant, of the spring elements 112 and 126. A spring constant is an intrinsic property of a spring, which describes its relative compliance to outside forces. Thus springs with low spring constants expand or comply more to outside forces than springs with high spring constants. The spring constants of spring elements 112 and 126 and any of the springs described herein may each be defined purely by the geometry and material of the springs. The stiffness of the spring elements 112, 126 and any of the springs described herein can be affected by temperature. Thus, changes in ambient or sensor temperature can result in changes in spring stiffness, resulting in changes in resonant frequency of the structure 100. Spring elements 112 and 126 and any of the springs described herein may be comprised of a uniform isotropic material, such as doped or undoped silicon. Springs may also have varying widths, segments, segment lengths, and moments of inertia to tailor portions of the springs and achieve the desired spring constants. While spring elements 112 and 126 are depicted in FIG. 1, the system 100 may include more spring elements.

The drive structures described herein may be capacitive comb drives as shown at 124. The comb drive 124 may have one set of stationary teeth 128 which are rigidly coupled to the bottom layer of the out-of-plane sensor, and a second, interdigitated set is connected to the sense mass such as the moveable element 102. The drive structure 124 may also be any device capable of driving the moveable element 102 into oscillation. The electrical signal controlling the drive structure 124 may be a constant electrical signal generated through feedback circuitry to maintain the desired oscillation frequency (such as the resonant frequency). The feedback circuitry may also adjust a drive voltage to the drive structures until the displacement amplitude of the moveable element 102 reaches a desired setpoint. This setpoint may be a displacement amplitude associated with the resonant frequency of the out-of-plane sensor 100, or any predetermined amplitude. Another example of a control signal may be a periodic “pinged” signal that is turned on and off, creating a stepped electrostatic force to initiate harmonic oscillation. The “pinged” signal may be coordinated between drive structures on opposite sides of the moveable element 102 in the z-axis, to create a “push/pull” electrostatic force. Drive structures may thus be placed above and below the moveable element 102 in the z direction. The drive structures may be powered on or off in response to a user initiating or closing an application on a mobile device, or any other on and off signal derived from the system coupled to the out-of-plane sensor 100. Start up times of oscillating sensors may range from 10 milliseconds to multiple seconds.

The moveable element 102 may be electrically isolated from the fixed element 104 to allow the application of an electronic bias voltage between the fixed element 104 and the moveable element 102. In some implementations, the moveable element 102 is electrically grounded while an electric bias is applied to the fixed element 104. In some implementations, the fixed element 104 is electrically grounded and an electric bias is applied to the moveable element 102. A sensing device such as a transimpedance amplifier or a current amplifier can be electrically connected to either the fixed element 104 or the moveable element 102 to process a capacitive or other electrical current resulting from operation of the sensor.

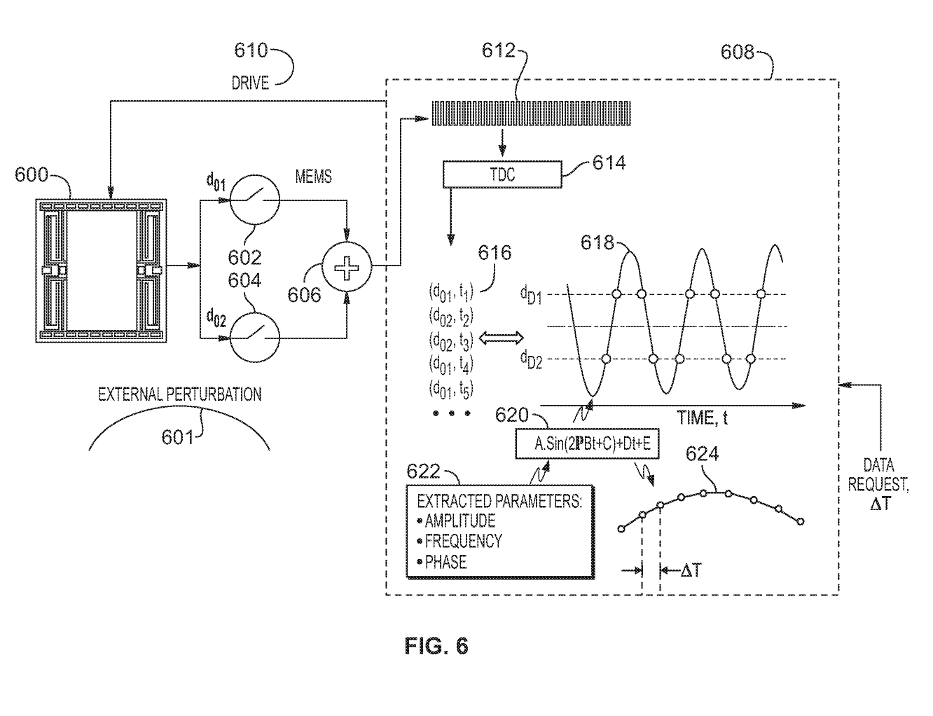

The voltage applied between fixed element 104 and moveable element 102 creates a potential difference between the two. Since the beams 106 and 108 are conductive, there is a capacitance across the gap separating beams 106 from 108. In general, capacitance increases with surface area and decreases with separation distance. Thus, increasing a separation offset between electrodes will decrease the capacitance. For example, the structures shown in FIG. 1 may have maximum capacitance when the beams 106 have the maximum surface area parallel to beams 108. When shifted in the horizontal direction, the capacitance may increase or decrease. The capacitive output signal of beams 106 and 108 is discussed in further detail with reference to FIGS. 6-34.

The movement of the element 102 in the z direction may produce a capacitive current. The relation between capacitance and capacitive current is discussed in further detail with respect to FIGS. 6-34. The beams 106 and 108 are shown in FIG. 1 as long, rectangular structures, however they may also be any of the other sensing structures described herein. In response to the motion of the moveable element 102, the capacitance between beams 106 and beams 108 may produce a nonlinear periodic signal. In particular, this may be a non-monotonic output signal in response to the monotonic motion of the moveable structure 102 in the z direction.

Monotonicity is the property of not reversing direction or slope, although a monotonic signal may have a zero slope and monotonic motion can also include no motion. Monotonic motion over a given range is thus motion that does not reverse its direction within that range. For example, motion that begins in one direction, stops, and then continues in the same direction is considered monotonic since the motion does not, in fact, reverse. A non-monotonic signal may be a signal that increases and then decreases.

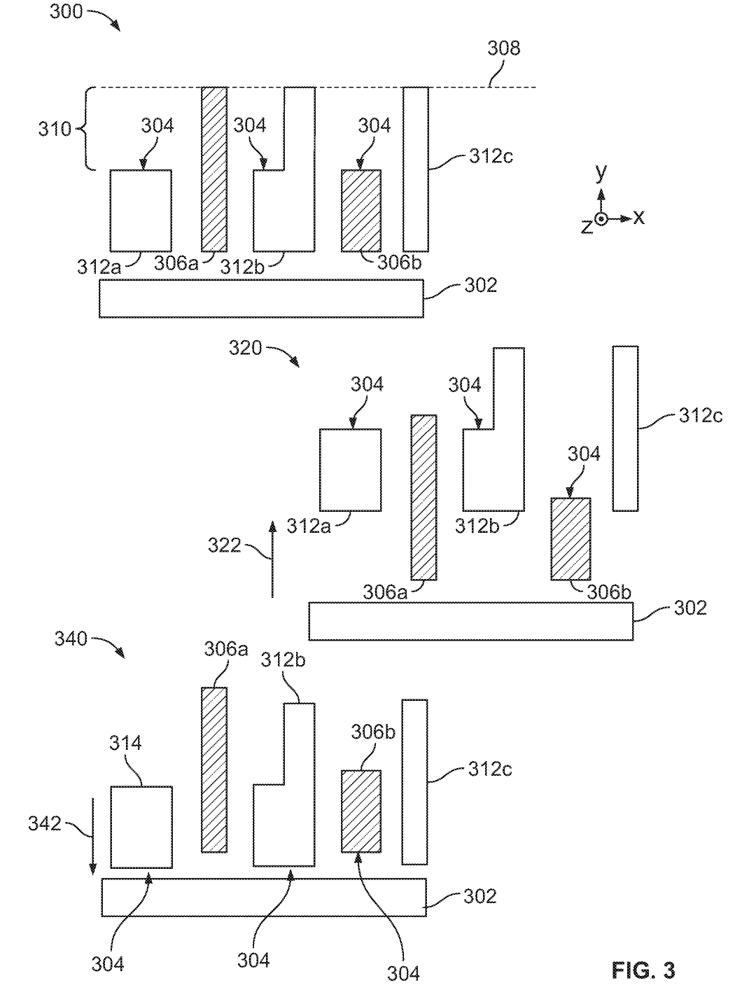

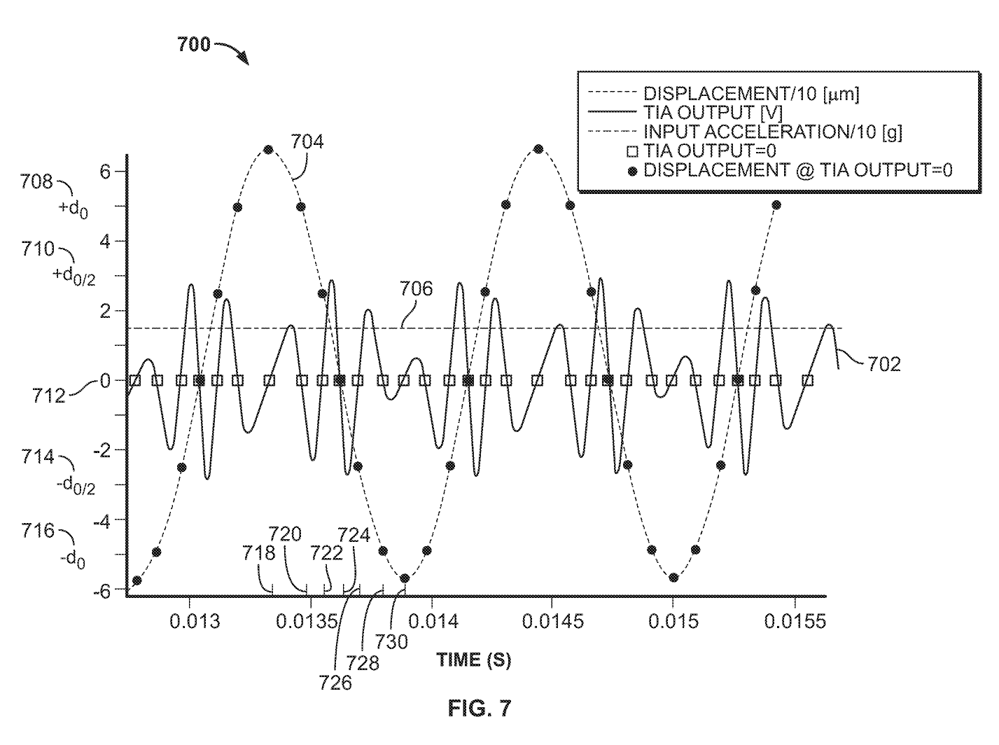

In the out-of-plane sensors described herein, some moveable components, such as 102, may experience motion that is monotonic over one range of its motion and not over another. One example of this may be that as moveable element 102 travels in the z direction to one extremum, momentarily stops at its maximum displacement, and then reverses direction and travels in the z direction to its minimum displacement, where it again stops, and repeats. This particular motion is describe in further detail with reference to FIGS. 2 and 3. In the range in which the oscillator travels only in the positive or negative z directions, its motion is monotonic. However, in any range including the minimums or maximums of displacement, the motion is non-monotonic. An output signal that is directly proportional to the position of the oscillator would be monotonic and non-monotonic over these same corresponding ranges. However, the systems and methods described herein can produce non-monotonic output signals from montonic motion. This is described in further detail with reference to FIGS. 7, 9, and 11-34

The periodic sensing structures shown in FIGS. 1-5 produce the non-monotonic signal from the oscillator's monotonic motion, as described above. The non-monotonic signal may be a function of the capacitance between various sensing structures described herein. Capacitance and changes in capacitance may be measured using an analog front end such as a transimpedance amplifier.

The structure 100 may be fabricated using a conductive material such as doped silicon. Elements of the structure 100, such as the moveable element 102, the fixed element 104, the comb drive 124, the spring element 126, and any other elements of the structure 100 can be fabricated by etching vertically into the doped silicon substrate. The fixed element 104 may be attached to a silicon wafer below (not shown) by bonding lower surfaces of bonding pads, such as bonding pads 116a, 116b, and 116c (collectively bonding pads 116) to the lower silicon wafer. This bonding can be accomplished through wafer bonding techniques. The moveable element 102 is coupled to the fixed element, and therefore to the lower silicon wafer, by the spring element 126, and also to the truss element 110, the spring element 112, and the bonding pad 114. The lower surface of the bonding pad 114 is also bonded to the lower wafer using wafer bonding techniques. The spring element 126, the truss element 110, and the spring element 112 comprise a linear spring system to maintain a constant stiffness over the moveable element 102's full range of motion in the z direction. The truss element 110 can be substantially etched away leaving a grid structure as depicted in FIG. 1. The truss element may also be entirely solid, or may be etched to a lesser degree than is depicted in FIG. 1.

FIG. 1 may depict a fraction of the out-of-plane sensor 100, such as one-fourth of the out-of-plane sensor 100. The out-of-plane sensor 100 may be substantially symmetric along each of the lines of symmetry 122 in the y axis and 120 in the x axis. A cap wafer (not shown) may be deposed above and bonded to the tops of the bonding pads 114 and 116 using wafer bonding techniques. The space between a bottom layer (not shown) and the cap layer may be at a constant pressure below atmospheric pressure. The space between the bottom layer and the cap layer may be at partial vacuum. A getter material such as titanium or aluminum may be deposited on the interior of the space to maintain reduced pressure over time. The pressure of the space between the top and cap layers may affect the quality factor (Q factor) of the out-of-plane sensor 100. In vibratory out-of-plane sensors, the Q factor defines the resonator's bandwidth relative to the center of its frequency response, as well as reflecting how under-damped the sense mass may be.

FIG. 2 depicts three cross views of a vertical sense structure for measuring out-of-plane displacements, according to an illustrative implementation. FIG. 2 shows the bottom layer 202 of the out-of-plane sensor, a sense mass comprised of connected segments 208a, 208b and 208c (collectively 208), and sense electrodes 204a and 204b. Each sense electrode 204a and 204b may independently produce an electrical signal, such as an analog electrical signal, a capacitive signal, or any other desired signal. The sense mass 208 has a pivot point 206, around which it rotates in a vertical direction as shown at 220 and 240. The sense mass 208 may be the moveable element 102 as shown in FIG. 1. At 200, the sense mass 208 may be at equilibrium, meaning that in the absence of drive forces or external perturbations, it would remain at this position. At 200, the sense mass may be parallel to the bottom layer 202.

The central anchor depicted at 206 may include springs to mechanically couple the moveable element to a fixed element. The central anchor depicted at 206 may be rigidly coupled to the bottom layer 202. The sense mass may be driven by drive structures (not shown) positioned below the sense mass 208 on the bottom layer 202, or in any other configuration capable of producing the oscillation shown at 200, 220 and 240. The electrodes 204a and 204b are spaced at a radius 212 and 210, respectively, from a rotational pivot point 206 of the proof mass. Radius 210 is smaller than radius 212. Additionally, as shown, the electrode 204b has a smaller area than the electrode 204a, and thus 204b has a smaller nominal capacitance than 212. The electrodes 204a and 204b may be rigidly coupled to the bottom layer 202. They are shown as separated by the segment of the sense mass 208b. The electrode 204a may be independently monitored from electrode 204b, and they may thus be electrically isolated from each other.

The inner walls of the sense mass, shown at 214, interface with the sense electrodes 204a and 204b, and may contain electrodes or capacitive plates, meaning that the sense electrodes and sense masses may form parallel plate capacitors between each other, producing capacitive current as the result of their relative movement and change in capacitance. Additionally, as shown, the first electrode 204b has a smaller area than the second electrode 204a, and thus the first electrode has a smaller nominal capacitance than the second electrode.

At 220, the sense mass 208 has reached its maximum vertical displacement, forming a positive altitude angle 222 as a result of the movement of its free end as indicated by arrow 224. At 240, the sense mass 208 has reached its minimum vertical displacement, forming a negative altitude angle 242 as a result of the movement of its free end as indicated by arrow 244. Angle 222 may have the same magnitude as angle 242.

As the proof mass rotates in the directions indicated at 224 and 244, both the capacitance of the first electrode 204b and second electrode 204a will decrease from the maximum capacitance shown at position 200. Since the second electrode 204a is positioned at a larger radius 212, the electrode has an offset relative to the tilting proof mass that increases faster than that of the first electrode 204b. This also means that the second electrode 204a's capacitance decreases faster than that of the first electrode 204b. As such, during a rotation of the proof mass 208, the second electrode 204a's capacitance decreases from a magnitude greater than to a magnitude less than that of the first electrode 204b's capacitance. Thus, at some particular altitude angle ±φ, the capacitance of the first electrode 204b and the second electrode 204a will be equal, giving a differential capacitance of zero at angle ±φ. This capacitance relation between the first electrode 204b and the second electrode 204a is shown in further detail with reference to FIGS. 19-28. An algorithm, such as the Cosine algorithm of equation (1), or another trigonometric or nonlinear algorithm is able to use these points of zero differential capacitance to determine acceleration and other inertial parameters.

FIG. 3 depicts three cross views of a second vertical sense structure for measuring out-of-plane displacements, according to an illustrative implementation; FIG. 3 shows the bottom layer 302 of the out-of-plane sensor, a sense mass comprised of connected segments 312a, 312b and 312c (collectively, 312), and sense electrodes 306a and 306b. Sense electrodes 306a and 306b may each produce an independent electrical signal, such as an analog electrical signal, a capacitive signal, or any other desired signal. The sense mass 312 may have a pivot point (not shown) located at the left-most end of sense mass segment 312a as shown in FIG. 3, which allows it to oscillate in the vertical direction as shown at 320 and 340. The sense mass 312 may be the moveable element 102 as shown in FIG. 1. At 300, the sense mass 312 may be at equilibrium, meaning that in the absence of drive forces or external perturbations, it would remain at this position. At 300, 320 and 340, the sense mass may be parallel to the bottom layer 302.

The pivot point may include springs to mechanically couple the sense mass 312 to a non-moveable portion of a out-of-plane sensor. The pivot point may be rigidly coupled to the bottom layer 302. The sense mass 312 may be driven by drive structures (not shown) positioned below the sense mass 312 on the bottom layer 302, or in any other configuration capable of producing the oscillation shown at 320 and 340. Electrode 306a has the same area as electrode 306b, and electrodes 306a and 306b may be rigidly coupled to the bottom layer 302.

In the equilibrium position 300, the first electrode 306a is vertically offset upward relative to the proof mass segment 312a, and the second electrode 306b is vertically offset downward to the proof mass segment 312c. Segment 312b is offset downward to the first electrode 306a on the left side, and offset upwards to the second electrode 306b on the right side. As shown in FIG. 3, this is achieved by aligning the bottoms of the proof masses and the bottoms of the electrodes 306a and 306b, and etching a gap of distance 310 shown at 304. This gap may be approximately 4 μm deep.

At 320, the proof mass 312 has moved in the vertical z direction as indicated by the arrow 322. At 320, the proof mass 312 may have reached its maximum positive displacement in the z direction. At 340, the proof mass 312 has moved in the negative z direction as indicated by the arrow 342. At 340, the proof mass 312 may have reached its minimum negative z displacement. As the proof mass 312 oscillates in the z direction, it may move from position 320, to position 300, to position 340, and then back to 300 and 320 to complete a full oscillation cycle.

As the proof mass moves in the directions indicated at 322 and 342, one electrode's capacitance will increase and the other electrode's capacitance will decrease. For example, as proof mass 312 lowers, the second electrode 306b that has a downward offset will approach a maximum capacitance when the second electrode 306b and the proof mass 312 are aligned. The first electrode 306a, which has an upward offset, will have a decrease capacitance as the electrode's vertical separation from the proof mass 312 increases. The converse is true as the proof mass 312 moves in the positive z direction. As a specific upward position, the first electrode 306a's capacitance will have a maximum, and at a specific downward vertical position, the second electrode 306b will have a maximum. At each of these maxima, the slope of the capacitance with respect to time will be zero as the proof mass translates in the z direction. Because these zero-slope points correspond to fixed proof mass positions, an algorithm, such as the Cosine algorithm as shown in equation (1), or any other trigonometric or nonlinear algorithm, is able to use these points to determine acceleration.

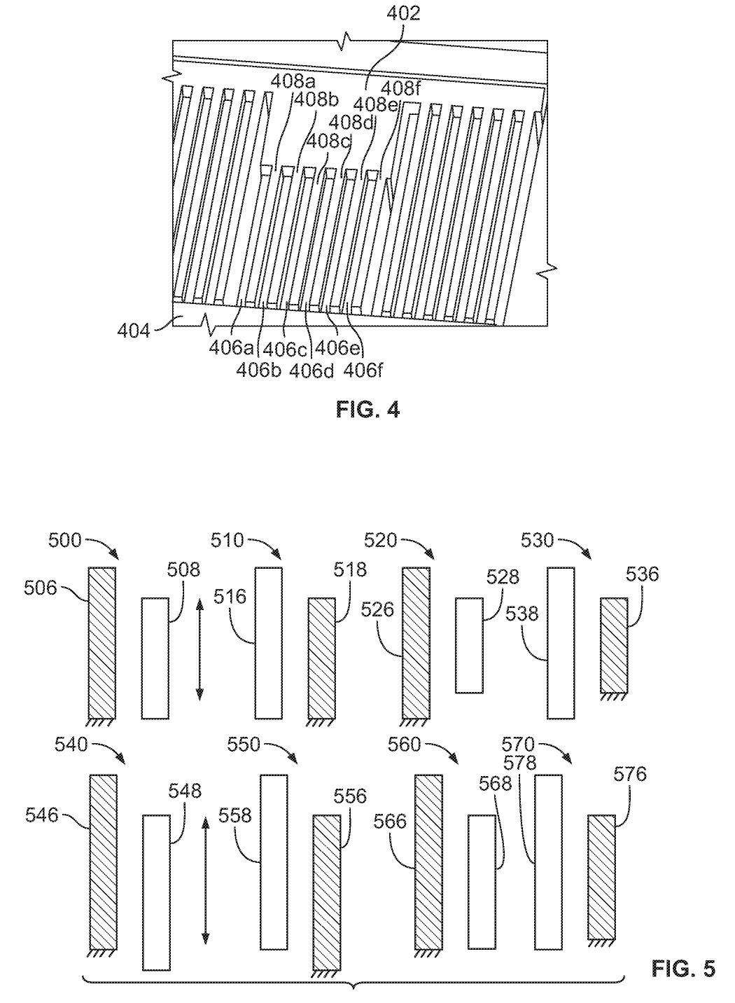

FIG. 4 depicts a perspective view of an inertial device that may be used to measure out-of-plane displacements, according to an illustrative implementation. FIG. 4 shows the moveable element 402, with beams 408a, 408b, 408c, 408d, 408e and 408f (collectively, beams 408), and fixed element 404, with beams 406a, 406b, 406c, 406d, 406e and 406f (collectively, beams 406). The beams 408 may be etched in the vertical dimension more or less than beams 406, creating differences in the capacitive signals produced as a result of the moveable element 402's oscillation in the vertical dimension. These relative capacitive differences between beams are discussed with more detail in FIG. 5. Any of the views shown in FIG. 5 may be implemented by etching the beams 406 or 408 as shown in FIG. 4.

FIG. 5 depicts eight configurations of fixed and moveable beams which may be used to sense out-of-plane displacements, according to an illustrative implementation. FIG. 5 includes views 500, 510, 520, 530, 540, 550, 560, and 570. The view 500 includes a fixed beam 506 and a moveable beam 508 that is shorter than the fixed beam 506. At rest, the lower surface of the moveable beam 508 is aligned with the lower surface of the fixed beam 506. As the moveable beam is displaced upward by one-half the difference in height between the two beams, the capacitors between the two beams is at a maximum. When the capacitance is at a maximum, the capacitive current is zero and can be detected using a zero-crossing detector as described herein.

The view 510 includes a moveable beam 516 and a fixed beam 518. The moveable beam 516 is taller than the fixed beam 518, and the lower surfaces of the moveable fixed beams are aligned in the rest position. As the moveable beam is displaced downward by a distance equal to one-half the distance in height of the two beams, capacitance between the two beams is at a maximum.

The view 520 includes a fixed beam 526 and a moveable beam 528 that is shorter than the fixed beam 526. The center of the moveable beam is aligned with the center of the fixed beam such that in the rest position, the capacitance is at a maximum.

The view 530 includes a fixed beam 536 and a moveable beam 538 that is taller than the fixed beam 536. At rest, the center of the moveable beam 538 is aligned with the center of the fixed beam 536 and capacitance between the two beams is at a maximum.

The view 540 includes a fixed beam 546 and a moveable beam 548 that is the same height as the fixed beam 546. At rest, the lower surface of the fixed beam 546 is above the lower surface of the moveable beam 548 by an offset distance. As the moveable beam 548 moves upward by a distance equal to the offset distance, capacitance between the two beams is at a maximum because the overlap area is at a maximum.

The view 550 includes a fixed beam 556 and a moveable beam 558 that is the same height as fixed beam 556. In the rest position, the lower surface of the moveable beam 558 is above the lower surface of the fixed beam 556 by an offset distance. As the moveable beam travels downward by a distance equal to the offset distance, the overlap between the two beams is at a maximum and thus capacitance between the two beams is at a maximum.

The view 560 includes a fixed beam 566 and a moveable beam 568 that is shorter than the fixed beam 566. In the rest position, the lower surfaces of the two beams are aligned. As the moveable beam 568 moves upwards by a distance equal to one-half the difference in height between the two beams, overlap between the two beams is at a maximum and thus capacitance is at a maximum.

The view 570 includes a fixed beam 576 and a moveable beam 578 that is taller than the fixed beam 576. In the rest position, the lower surface of the moveable beam 578 is below the lower surface of the fixed beam by an arbitrary offset distance. As the moveable beam 578 moves downwards such that the center of the moveable beam 578 is aligned with the center of the fixed beam 546, the overlap area reaches a maximum and thus capacitance between the two beams reaches a maximum. For each of the configurations depicted in FIG. 5, a monotonic motion of the moveable beam produces a non-monotonic change in capacitance resulting in an extremum in capacitance. For all of the configurations depicted in FIG. 5, when capacitance between the two beams is at a maximum, the capacitive current is zero. The beams shown in FIG. 5 may be used to measure time intervals between zero-crossings. These zero-crossings may be used to determine inertial parameters.

FIG. 5 shows the variations in etching that may cause capacitive differences between sense electrodes of fixed and moveable elements of the out-of-plane sensor. Any of the views 500, 510, 520, 530, 540, 550, 560 or 570 may be used as variations of the sense electrodes shown in FIG. 2 and FIG. 3 to produce differential signals and zero-crossings from two different signals of the same moveable element.

FIG. 6 is a schematic of a process used to extract inertial information from an inertial sensor with out-of-plane sensing, according to an illustrative implementation. FIG. 6 shows an inertial sensor 600, which may be an out-of-plane sensor, which experiences an external perturbation 601. A drive signal 610 causes a moveable portion of the sensor 600 to oscillate. Zero-crossings of an output signal from the out-of-plane displacement sensor are generated at 602 and 604 and combined at 606 into a combined signal. Zero-crossings may be the product of differential sensing between multiple signal outputs, such as those produced by electrodes 202a, 202b, 306a and 306b of FIG. 2 and FIG. 3 respectively. A signal processing module 608 processes the combined analog signal to determine inertial or other sensing information desired. One or more processes can convert the analog signal into a rectangular waveform 612. This can be accomplished using a comparator, by amplifying the analog signal to the rails, or by other methods. A time-to-digital converter (TDC) 614 can be used to determine rising and falling edges of the rectangular signal 612. These rising and falling edges are associated with zero-crossings of the combined signal. The combined analog signal may also be converted using an analog-to-digital converter (ADC) into a digital representation, and zero-crossing times of the digital ADC output signal determined using linear, spline, or polynomial interpolation near the zero-crossing points. These zero-crossings may be derived from differential sensing, or may be the result of multiple signals. Zero-crossings may exclude zero velocity points in the output signal. These zero-crossing times 612 may also be part of a periodic waveform 618 that may be approximated by the function 620. By fitting the zero-crossing times 616 to the function 620, inertial parameters or other values 622 can be related to the external perturbation 601 acting on the out-of-plane displacement sensor. Time intervals 624 can also be extracted from the fit to the function 620. Because the zero-crossings are associated with specific physical locations of movable portions of the sensor, displacement information can be reliably determined independent of drift, creep, and other factors that tend to degrade the performance of inertial sensors, and linear inertial sensors in particular.

FIG. 7 is a graph representing the relationship between analog signals derived from an out-of-plane sensor and the displacement of a moveable element of the sensor, according to an illustrative implementation. This oscillator may be the sense mass of a out-of-plane sensor coupled to a TDS structure. The graph 700 includes curves 702, 704, and 706. The curve 702 represents an output of an AFE such as a transimpedence amplifier (TIA). Since a TIA outputs a signal proportional to its input current, the curve 702 represents a capacitive current measured between moveable and fixed elements of a out-of-plane sensor. The curve 706 represents an input acceleration applied to the accelerometer. The input acceleration represented by curve 706 is shown as a 15 g acceleration at 20 Hz, but may be any outside perturbation, force or acceleration. The curve 704 represents displacement of the sense mass of a composite mass inertial sensor.

FIG. 7 includes square symbols indicating points at which the curve 702 crosses zero. Since capacitive current 702 is proportional to the first derivative of capacitance, these zero-crossings in the current represent local maxima or minima (extrema) of capacitance between a moveable element and a fixed element of the out-of-plane sensor. FIG. 7 includes circular symbols indicating points on the curve 704 corresponding to times at which curve 702 crosses zero. The circular symbols indicate the correlation between the physical position of a moveable element of the out-of-plane sensor and zero-crossing times of the outputs of the signal 702.

At the time 718, the curve 702 crosses zero because the displacement 704 of the moveable element of the sense mass is at a maximum and the oscillator is instantaneously at rest. Here, capacitance reaches a local extremum because the moveable element has a velocity of zero, not necessarily because beams of the oscillator are aligned with opposing beams. At time 720, the TIA output curve 702 crosses zero because the oscillator displacement reaches the +d₀ location 708. The +d₀ location 708 corresponds to a displacement in a positive direction equal to the pitch distance and is a point at which opposing beams are aligned to produce maximum capacitance.

At time 722, the TIA output curve 702 crosses zero because the movable element of the oscillator is at a position at which it is anti-aligned. This occurs when the beams of the movable element are in an aligned position with the centers of gaps between beams of the fixed element, resulting in a minimum in capacitance. This minimum in capacitance occurs at a location of +d₀/2 710, corresponding to a displacement of one-half the pitch distance in the positive direction.

At time 724, the TIA output curve 702 crosses zero because beams of the movable element are aligned with beams of the fixed element, producing a maximum in capacitance. The time 724 corresponds to a time at which the movable element is at the rest position, indicated by the zero displacement 712 on the curve 704. At time 726, the TIA output 702 crosses zero because beams of the movable element are once again anti-aligned with beams of the fixed element, producing a local minimum in capacitance. This anti-alignment occurs at a displacement of −d₀/2 714, corresponding to a displacement of one-half the pitch distance in the negative direction.

At time 728, the TIA output 702 crosses zero because the beams of the movable element are in an aligned position with respect to the beams of the fixed element, creating a local maximum in capacitance. This local maximum in capacitance occurs at a displacement of −d₀ 716, corresponding to a displacement of the pitch distance in the negative direction. At time 730, the TIA output curve 702 crosses zero because the movable element has an instantaneous velocity of zero as it reverses direction. This reversal of direction is illustrated by the displacement curve 704. As at time 718, when the movable element has a velocity of zero, capacitance does not change with time and thus the current and TIA output (which are proportional to the first derivative of capacitance) are zero.

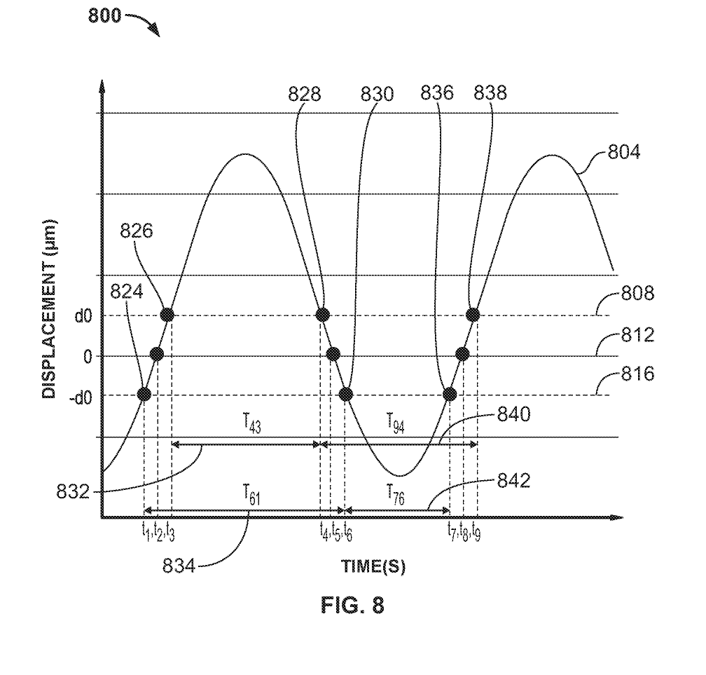

FIG. 8 is a graph showing time intervals produced from crossings of non-zero reference levels by the displacement of a moveable element of an out-of-plane sensor, according to an illustrative implementation. The graph 800 includes times 836 and 838. The graph 800 includes the time interval T₉₄ 840 and the time interval T₇₆ 842, which represent crossing times of the displacement curve 804 of reference levels 808 and 816 respectively. The time interval T₉₄ 840 corresponds to the time interval between times 828 and 838. The time interval T₇₆ 842 corresponds to the time interval between times 830 and 836. The graph 800 also includes time interval T₄₃ 832 and T₆₁ 834, corresponding to a time interval between times 826 and 828, and 824 and 830, respectively. The reference levels, shown at 808, 812, and 816 may be any value within the displacement range of the sense mass. The reference levels 808, 812 and 816 may be predetermined, and may correspond to the physical geometry of a TDS structure, such as the pitch distance between beams.

The time intervals shown in FIGS. 7-11 may be used to detect shifts of the displacement curve such as curve 804 shown in FIG. 8, and thus the input acceleration or forces acting on the out-of-plane displacement sensor. The relative positions of the zero-crossing times that produce these time intervals reflect these outside forces on the sensor. For example, a sum of the time intervals T₄₃ 832 and T₉₄ 840 represents a period of oscillation as does a sum of the periods T₆₁834 and T₃₆ 842. In comparing a subset of the period, such as comparing the time interval T₄₃ 832 with the sum of T₄₃ 832 and T₉₄ 840, one obtains the proportion of time that the oscillator spends at a displacement greater than the position +d₀ 708 as shown in FIG. 7. An increase in this proportion from a reference proportion (in which the sense mass is in equilibrium) indicates a greater acceleration in the positive out-of-plane direction. Likewise, a decrease in this proportion from the equilibrium indicates a greater acceleration in the negative out-of-plane direction. Other time intervals can be used to calculate other proportions and changes in acceleration. Displacement of the sense mass in the out-of-plane direction can be determined from the time intervals depicted in FIG. 8, or any of the other time intervals shown herein, using the following relations:

$$\begin{matrix}d = \frac{2 {d}_{0} cos ( π \frac{{T}_{61}}{{P}_{m 1}} )}{cos ( π \frac{{T}_{61}}{{P}_{m 1}} ) - cos ( π \frac{{T}_{43}}{{P}_{m 2}} )} - {d}_{0} & ( 1 ) \\ {P}_{m 1} = {T}_{61} + {T}_{76} & ( 2 ) \\ {P}_{m 2} = {T}_{43} + {T}_{94} & ( 3 )\end{matrix}$$

Where d (or Δz) represents the displacement of the sense mass in the vertical direction, d₀ is a reference position of the sense mass in its out-of-plane oscillation, Pₘ₁ is the period of time the sense mass spends below the reference position −d₀ as shown in FIG. 8, and Pₘ₂ is the amount of time the sense mass spends above the reference position d₀ as shown in FIG. 8. These reference positions may also be any reference position desired, and the time periods may refer to any reference time period desired. Using the relation between displacement Δz, external force F, and the effective spring constant k or compliance of the out-of-plane displacement sensor, given by Hooke's Law, one may thus determine from equation (1) an acceleration a, knowing the mass of the oscillator m:

F=kΔz=ma (4)

Out-of-plane displacement of the oscillator can be calculated recursively for each half cycle of the oscillator. Using this information, the displacement of the oscillator can be recorded as a function of time.

In some examples, the out-of-plane sensor includes periodic capacitive sensors, in which the capacitance between the sense mass and a fixed portion of the sensor varies non-monotonically as a function of z(t), which represents the out-of-plane displacement of the sense mass. This non-linear capacitive variation may be known, repeatable, and periodic. The non-linear capacitance produced by a single electrode may be modeled by a trigonometric or otherwise periodic function. The non-linear capacitance may be shown as:

$${S}_{MAP} ( t ) = {C}_{0} + {C}_{1} \cdot sin [ \frac{2 π}{P} \cdot x ( t ) ] = {C}_{0} + {C}_{1} \cdot sin [ \frac{2 π}{P} \cdot ( A sin ( {ω}_{d} t ) + Δ ) ] \qquad ( 5 )$$

Where C₀ and C₁ are constants that may be defined by the geometry of the sense electrodes, P is a period such as those give by equations (2) and (3), and ω_{d} is a frequency of oscillation in the out-of-plane direction. Using equation (5), one may utilize the relationship between capacitance and displacement to model the displacement by a periodic function, such as the following:

z(t)=A sin(ω_{d}t)+Δ (6)

Measurements of capacitance, given in equation (5), may thus allow one to solve for the variables in equation (6), such as frequency ω_{d}, offset Δ, amplitude A and displacement z(t). By repeatedly solving for these variables, the amplitude, frequency and offset of the motion of the sense mass can be determined with respect to time. The offset may be proportional to the external acceleration or other perturbing forces of measurement interest.

To obtain these parameters, the times at which the out-of-plane sensor has predetermined values of capacitance are measured. At these times, the sense mass is known to be at a position that is given by equation (7), where n is a positive integer.

$$\frac{2 π}{P} \cdot z ( t ) = n \cdot π \qquad ( 7 )$$

The oscillator is known to be at a displacement that is a multiple of P/2, where P is a period that may be given, for example, by equations (2) or (3), by tracking the number of times at which the capacitance equals the predetermined capacitance. The number of times at which the oscillator crosses displacements of P/2 can be tracked to overcome issues of degeneracy in capacitance. In particular, successive times at which the oscillator displacement equals +P/2 and −P/2 (δt and δt−, respectively) are measured and used to solve for A, ω_{d}, and Δ. Equation (8) shows the calculation of ω_{d} as a function of the time intervals.

$${ω}_{d} = \frac{2 π}{Period} = 2 π \frac{2}{( δ {t}_{1}^{+} + δ {t}_{2}^{+} + δ {t}_{1}^{-} + δ {t}_{2}^{-} )} \qquad ( 8 )$$

Exploiting the similarity of the measured time intervals combined with the fact that all time measurements were taken at points at which the capacitance equaled known values of capacitance and the oscillator displacement equaled integral multiples of P/2, the system of equations 9 and 10 can be obtained.

$$\begin{matrix}z ( t ) = + \frac{P}{2} = A \cdot cos ( {ω}_{d} \frac{δ {t}_{1}^{+}}{2} ) + Δ & ( 9 ) \\ z ( t ) = - \frac{P}{2} = A \cdot cos ( {ω}_{d} \frac{δ {t}_{1}^{-}}{2} ) + Δ & ( 10 )\end{matrix}$$

The difference of equations 5 and 6 allows the amplitude A to be determined as in equation (11).

$$A = \frac{P}{cos ( {ω}_{d} \frac{δ {t}_{1}^{+}}{2} ) - cos ( {ω}_{d} \frac{δ {t}_{1}^{-}}{2} )} \qquad ( 11 )$$

The sum of the equations 5 and 6 allows the offset Δ to be determined as in equation (12).

$$Δ = - \frac{A}{2} \cdot [ cos ( {ω}_{d} \frac{δ {t}_{1}^{+}}{2} ) + cos ( {ω}_{d} \frac{δ {t}_{1}^{-}}{2} ) ] \qquad ( 12 )$$

In some examples, an excitation field itself is varied with time. For example one or more of the components is attached to a compliant structure but is not actively driven into oscillation. Instead, the time varying signal is generated by varying, for example, voltage between the components. External perturbations will act on the compliant component, causing modulation of the time-varying nonlinear signal produced by the component.

Nonlinear, non-monotonic, time varying signals can be generated with a fixed set of electrically decoupled structures with which a nonlinear time-varying force of variable phase is generated. The time-varying force may be caused by the application of voltages of equal magnitude and different phase to each of the set of structures. This generates signals at phases determined by the phase difference of the applied voltages.

Sets of nonlinear signals with identical or differing phases can be combined to form mathematical transforms between measured output signals and system variables such as amplitude, offset, temperature, and frequency. Combinations of nonlinear signals with identical or differing phases can be included to minimize or eliminate a time varying force imparted on a physical system that results from measurement of the nonlinear signal. For example, two separate signals can be included within the system at 0° and 180° of phase, such that each signal is the inverse of the other. An example set of signals of this nature are the signals +A*sin(ωt) and −A*sin(ωt) for phases of 0° and 180° respectively.

Mathematical relationships between the periodic nonlinear signals and external perturbations can be applied to extract inertial information. For example, mathematical relationships can be applied in a continuous fashion based on bandwidth and data rates of the system. In some examples, mathematical relationships can be applied in a periodic sampled fashion. Mathematical relationships can be applied in the time or the frequency domains. Harmonics generated by the sensor can be utilized mathematically to shift frequency content to enable filtering and removal of lower frequency, drift-inducing noise. Harmonics can also be used to render the sensor insensitive or immune to these drift-inducing noise sources by applying one or more mathematical relationships to decouple the inertial signal from other system variables.

In some implementations, assist structures uniquely identify when external perturbations cause an offset in the physical structure of the device. Offsets can be integral or non-integral multiples of a pitch of tooth spacing. These assist structures are electrically isolated from one another and from the main nonlinear periodic signal.

To sense external perturbations in the z axis, normal to the plane of the wafer, corrugations may be formed on one or more surface of the sensor. In some examples, corrugated comb fingers are formed with height differences. In some examples, vertically corrugated teeth are formed in a self-aligned in-plane structure used for x or y axis sensing. In some examples, vertical corrugations are added to one or more plates of a capacitor.

In some examples, materials used to form the device may be varied spatially to result in a time-varying component of capacitance resulting from device motion. For example, oxides, other dielectrics, metals, and other semiconductors can be deposited or patterned with spatial variations. These spatial variations in dielectric constant will result in time variations of capacitance when components of the sensor are moved relative to each other. In some examples, both top and bottom surfaces of silicon used to form a proof mass include vertical corrugations. In some examples, both top and bottom cap wafers surrounding the device layer of silicon include vertical corrugations. In some examples, one or more of spatial variations in material, corrugation of the top of the device layer of silicon, corrugation of the bottom device layer of silicon, corrugation of the top cap wafer, and corrugation of the bottom cap wafer are used to form the sensor. In some examples, a vernier capacitor structure is used to form the sensor.

Signals output by the systems and methods described herein can include acceleration forces, rotational forces, rotational accelerations, changes in pressure, changes in system temperature, and magnetic forces. In some examples, the output signal is a measure of the variation or stability of the amplitude of a periodic signal, such as the oscillator displacement. In some examples, the output signal is a measurement in the variation or stability of the frequency of the periodic signal. In some examples, the output is a measurement of the variation or stability of the phase of the periodic signal. In some examples, the output signal includes a measurement of time derivatives of acceleration, such as jerk, snap, crackle, and pop, which are the first, second, third, and fourth time derivatives of acceleration, respectively.

In addition to measuring the inertial parameters from time intervals, in some examples, periodicity in physical structures is utilized to detect relative translation of one of the structures by tracking rising and falling edges caused by local extrema of capacitance, these local extrema of capacitance corresponding to translation of multiples of one half-pitch of the structure periodicity. The number of edges counted can be translated into an external acceleration. In some examples, an oscillation is applied to the physical structure, and in other examples, no oscillation force is applied to the physical structure.

A nonlinear least-squares curve fit, such as the Levenburg Marquardt curve fit, can be used to fit the periodic signal to a periodic equation such as equation 13.

A sin(Bt+C)+Dt+E (13)

In equation 9, A represents amplitude, B represents frequency, C represents phase, E represents the offset of an external acceleration force, and D represents the first derivative of the external acceleration force, or the time-varying component of acceleration of the measurement. The measurement period is one-half of the oscillation cycle. Additionally, higher-order polynomial terms can be included for the acceleration as shown in equation 14.

A sin(Bt+C)+Dt³+Et²+Ft+G+ (14)

In some examples, the input perturbing acceleration force can be modeled as a cosine function as shown in equation 15, in which D and E represent the amplitude and frequency of the perturbing acceleration force, respectably.

A sin(Bt+C)+D cos(Et) (15)

If the external perturbing acceleration is small in comparison to the internal acceleration of the oscillator itself, a linear approximation may be used to model the perturbing acceleration. In this case, the offset modulation is taken to be small in comparison to the overall amplitude of the generated periodic signal. By doing so, a measurement of a single time period can be taken to be linearly proportional to the external perturbing force. In some examples, multiple time periods may be linearly converted into acceleration and then averaged together to obtain lower noise floors and higher resolution.

In some examples, analysis in the frequency domain may be performed based on the periodic nature of the nonlinear signals being generated, as well as their respective phases. Frequency domain analysis can be used to reject common-mode noise. Additionally, the non-zero periodic rate of the signal can be used to filter out low frequency noise or to high-pass or band-pass the signal itself to mitigate low-frequency drift.

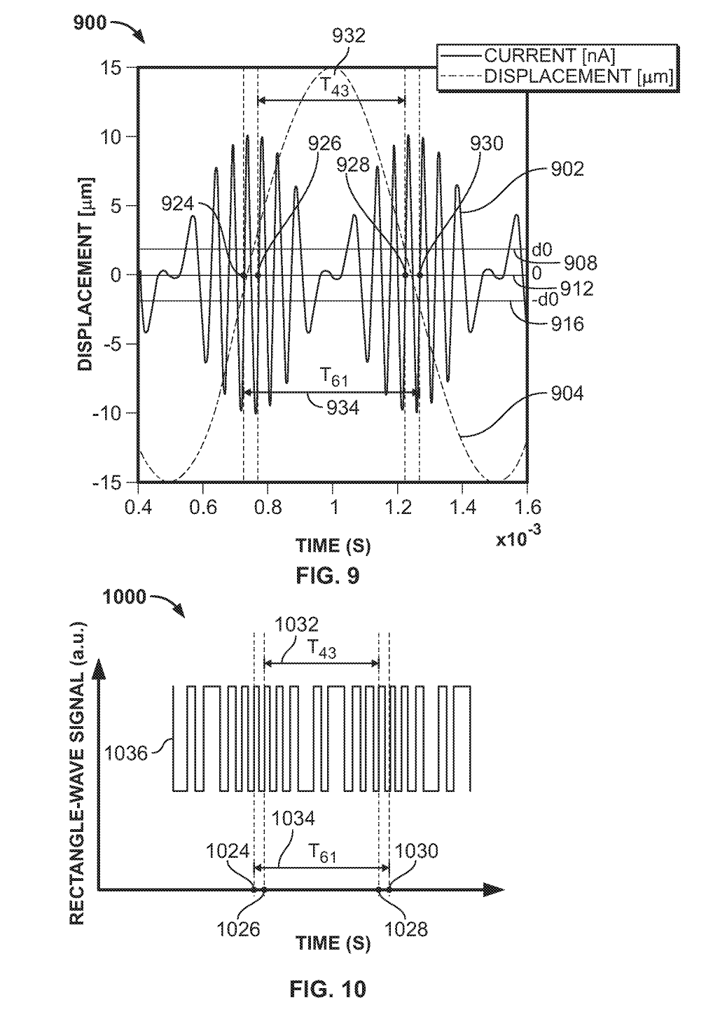

FIG. 9 is a graph illustrating the current response to the displacement of a moveable element of an out-of-plane sensor, according to an illustrative implementation. The graph 900 includes a current curve 902 and a displacement curve 904. The current curve 902 represents an input signal for a TIA and may be produced by TDS structures coupled to a sense mass of an out-of-plane sensor. The TIA may produce an output signal such as the TIA output curves 902 as shown in FIG. 9 in response to displacement of the sense mass of an out-of-plane sensor, and may represent the output of a single electrode or an x-y sensor used in conjunction with vertical sensing. The current curve 902 is a capacitive current generated between fixed and movable elements of the out-of-plane sensor in response to displacement 904. The current curve 902 crosses zero at numerous times, including times 924, 926, 928, and 930. At the times 924 and 930, the movable element has a displacement of −d₀, where d₀ may correspond to the pitch distance between teeth of a TDS structure. At the times 926 and 928, the movable element has a displacement of +d₀.

The graph 900 includes two time intervals T₄₃ 932 and T₆₁934. The time interval T₄₃ 932 corresponds to the difference in time between time 926 and time 928. The time interval T₆₁ 934 corresponds to the time difference between times 924 and 930. Thus, time interval T₆₁ 934 corresponds to the time between subsequent crossings of the −d₀ 916 location, and the time interval T₄₃ 932 corresponds to the time interval between subsequent crossings of the +d₀ 908 location. The methods used to determine the time intervals T₄₃ 932 and T₆₁ 934 can be used to determine other time intervals, such as between a crossings of the +d₀ 908 and the next subsequent crossing of the −d₀ 916 level, between a time interval between a crossing of the −d₀ 916 level and the next crossing of the +d₀ 908 level, between the time 930 and the next crossing of the +d₀ 908 level, between crossings of the zero 912 level, between zero-crossings due to a maximum or minimum of displacement, or between any other combination of zero-crossings of the current curve 902 or a TIA output signal corresponding to the current curve 902.

FIG. 10 is a graph showing a rectangular-wave signal produced from zero-crossing times of the current signal depicted in FIG. 9, according to an illustrative implementation. The graph 1000 includes a rectangular waveform curve 1036. The rectangular waveform curve 1036 has substantially two values: a high value and a low value. While the rectangular waveform curve 1036 may have intermediate values as it transitions between the high and low values, the time spent at intermediate values is far less than the combined time spent at the high and low of the values.

The rectangular waveform curve 1036 can be produced by a variety of methods, including using a comparator to detect changes in an input signal, by amplifying an input signal to the limits of an amplifier so as to saturate the amplifier (amplifying to the rails), by using an analog-to-digital converter, and the like. One way to produce this rectangular waveform curve 1036 from the current curve 902 shown in FIG. 9 is to use a comparator to detect zero-crossings of the current curve 902. When the current curve 902 has a value greater than a reference level (such as zero), the comparator outputs a high value, and when the current curve 902 has a value less than the reference level (such as zero), the comparator has a low value. The comparator's output transitions from low to high when the current curve 902 transitions from a negative value to a positive value, and the comparator's output transitions from high to low when the current curve 902 transitions from a positive value to a negative value. Thus, times of rising edges of the rectangular waveform curve 1036 correspond to times of negative-to-positive zero-crossings of the current curve 902 and falling edges of the rectangular waveform curve 1036 correspond to positive-to-negative zero-crossings of the current curve 902. This can be seen at time 1024, where the rectangular waveform curve 1036 transitions from a negative to positive value, corresponding to a zero crossing at 924 in FIG. 9. The same can be seen at time 1028 corresponding to zero crossing 928. The rectangular waveform curve 1036 transitions from a positive value to a negative value at times 1026 and 1030, corresponding to a zero crossing at 926 and 930 in FIG. 9, respectively.

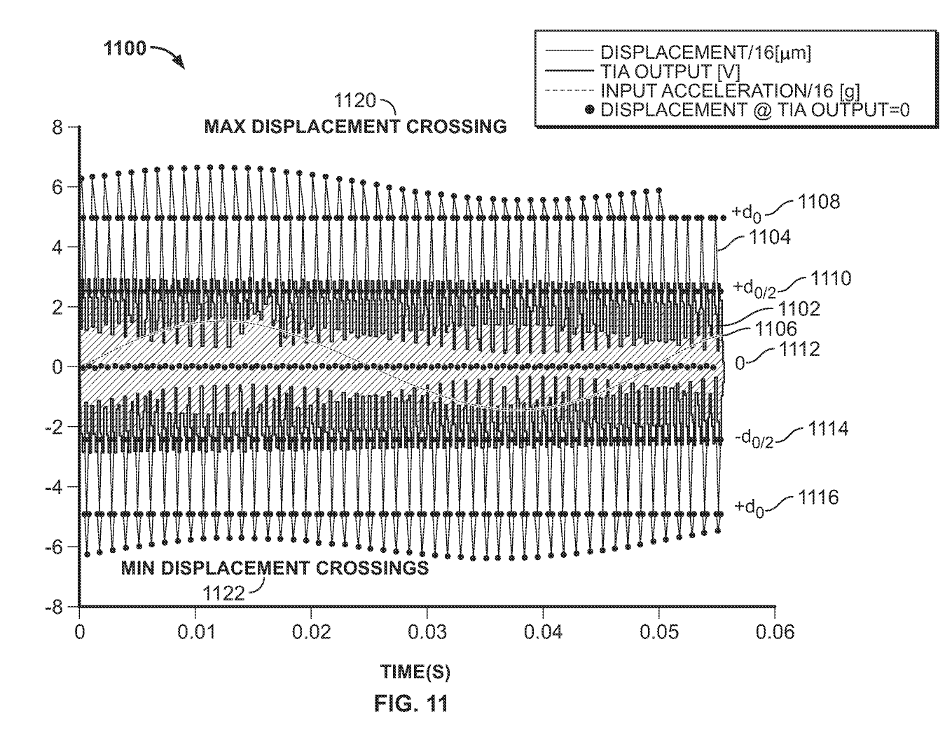

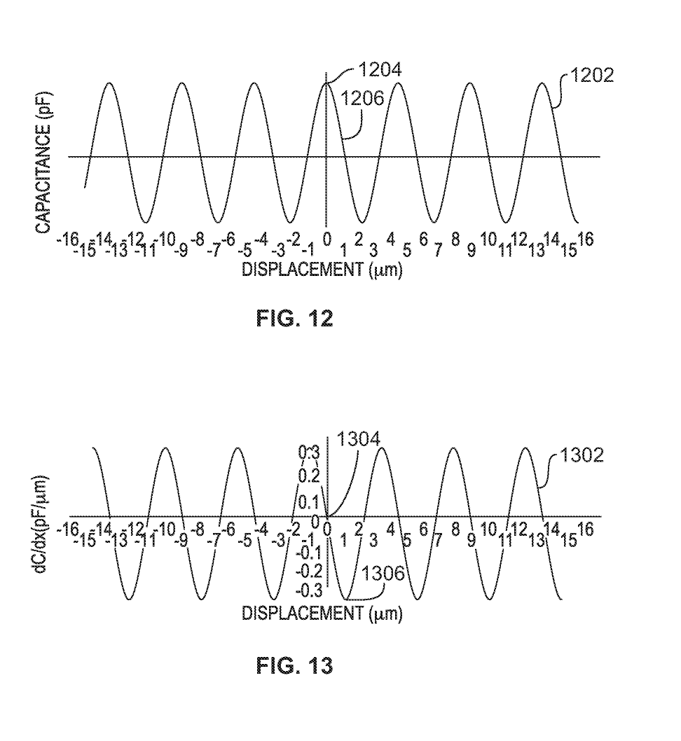

The rectangular waveform curve 1036 includes the same time intervals 932 and 934 as the current curve 902. One benefit of converting the current curve 902 to a rectangular waveform signal such as the rectangular waveform curve 1036 is that in a rectangular waveform signal, rising and falling edges are steeper. Steep rising and falling edges provide more accurate resolution of the timing of the edges and lower timing uncertainty. Another benefit is that rectangular waveform signals are amenable to digital processing. The rectangular waveform 1036 may also be produced from zero-crossings of any of the signals described in FIGS. 12-34.

FIG. 11 is a graph showing the effects of an external perturbation on the output signal of an out-of-plane sensor, according to an illustrative implementation. FIG. 11 is a graph showing the effects of an external perturbation on the output signal of the out-of-plane sensor, according to an illustrative implementation. The graph 1100 includes the output curve 1102, a displacement curve 1104, and an input acceleration curve 1106. FIG. 11 also depicts the reference pitch locations +d₀ 1108, +d₀/2 1110, 0 1112, −d₀/2 1114, and −d₀ 1116, where d₀ is a reference position of a TDS structure. The graph 1100 depicts the same signals depicted in the graph 900 and 700 of FIGS. 9 and 7 respectively, with the x axis of 1100 representing a longer duration of time than is shown in the graph 900 or 700. The periodicity of the input acceleration curve 1106 is more easily discerned at this time scale. In addition, maximum displacement crossings 1120 and minimum displacement crossings 1122 can be discerned in the graph 1100 to experience a similar periodicity. In contrast to the maximum displacement crossings 1120 and the minimum displacement crossings 1122, the amplitude of which varies with time, zero-crossings of the output signal 1102 triggered by alignment or anti-alignment of the fixed and movable elements at the locations +d₀ 1108, +d₀/2 1110, 0 1112, −d₀/2 1114, and −d₀ 1116 are time invariant. These reference crossings, the amplitude of which are stable with time, provide stable, drift-independent indications of sense mass vertical displacement and can be used to extract inertial parameters.

FIG. 12 is a graph depicting capacitance as a function of the displacement of a moveable element of an out-of-plane sensor, according to an illustrative implementation. FIG. 12 includes a capacitance curve 1202 that is periodic and substantially sinusoidal. Thus, monotonic motion of a movable element produces a capacitance that changes non-monotonically with displacement. This non-monotonic change is a function of the geometric structure of the TDS structures shown with reference to FIGS. 1-5, and the manner in which the out-of-plane sensor is excited.

FIG. 13 is a graph depicting the first spatial derivative of capacitance as a function of the displacement of a moveable element of an out-of-plane sensor, according to an illustrative implementation. FIG. 13 includes a dC/dx curve 1302 which is periodic and substantially sinusoidal. The dC/dx curve 1302 is the first derivative of the capacitance curve 1202. As such, the dC/dx curve 1302 crosses zero when the capacitance curve 1202 experiences a local extremum. Capacitive current is proportional to the first derivative of capacitance and thus proportional to, and shares zero-crossings with, the dC/dx curve 1302.

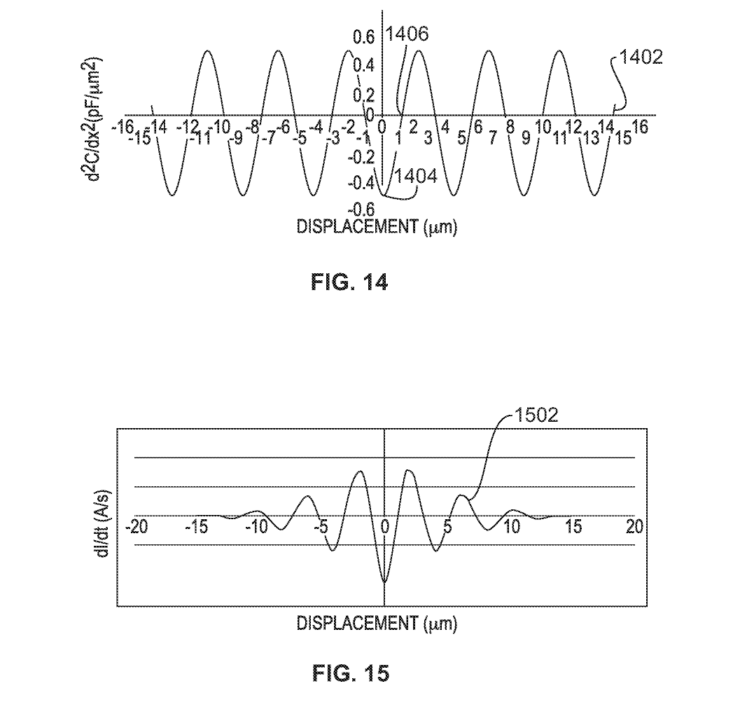

FIG. 14 is a graph depicting the second spatial derivative of capacitance as a function of the displacement of a moveable element of an out-of-plane sensor, according to an illustrative implementation. FIG. 14 includes a d²C/dx² curve 1402. The dC/dx² curve 1402 is the first derivative of the dC/dx curve 1302 and as such has a value of zero at local extrema of the dC/dx curve 1302. The d²C/dx² curve 1402 indicates the slope of the dC/dx curve 1302 and thus indicates locations at which the current is most rapidly changing. In some implementations, it is desirable to maximize the amplitude of the d²C/dx curve 1402 to maximize the steepness of the current curve. This reduces uncertainty in resolving timing of zero-crossings of the current. Reducing uncertainty of the zero-crossing times results in decreased system noise and decreased jitter, as well as, lower gain required of the system. Decreased jitter results in improved resolution of external perturbations. In some implementations, it is desirable to minimize the impact of variable parasitic capacitance, which is parasitic capacitance that varies with sense mass motion.

FIG. 15 is a graph depicting the time derivative of the capacitive current as a function of the displacement of a moveable element of an out-of-plane sensor, according to an illustrative implementation. FIG. 15 includes a dI/dt curve 1502. The capacitive current used to determine the dI/dt curve 1502 is obtained by applying a fixed voltage across the capacitor used to produce the capacitive curve 1202. The dI/dt curve 1502 represents the rate at which the capacitive current is changing with time and thus provides an indicator of the steepness of the current slope. High magnitudes of the dI/dt signal indicate rapidly changing current and high current slopes. Since the sense mass used to generate the curves shown in FIGS. 12-14 oscillates about zero displacement and reverses direction at minimum and maximum displacements, the velocity of the sense mass is lowest at its extrema of displacement. At these displacement extrema, the current is also changing less rapidly and thus the dI/dt curve 1502 has a lower magnitude. Using zero-crossings at which the dI/dt curve 1502 has large values results in improved timing resolution and decreased jitter. These zero-crossings occur near the center of the sense mass's range.

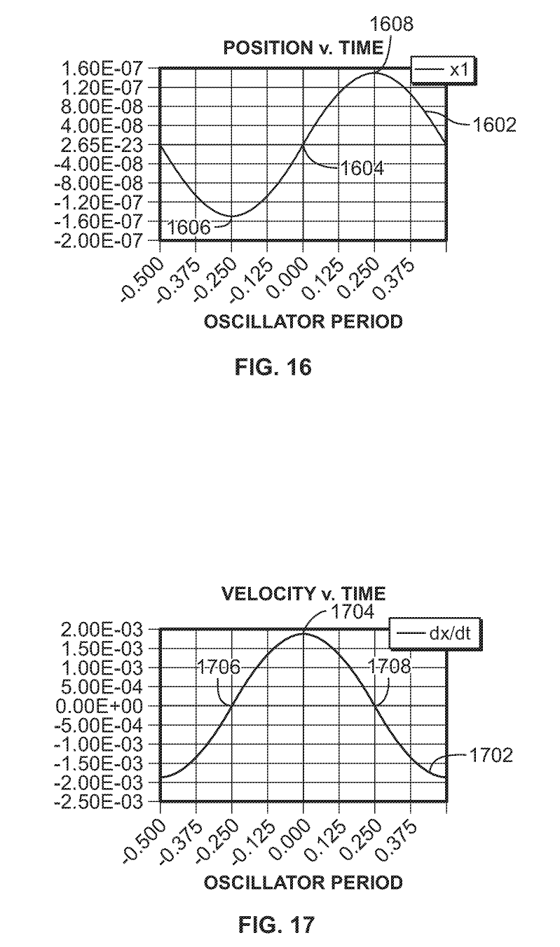

FIG. 16 is a graph representing the position of a moveable element of an out-of-plane sensor relative to time, according to an illustrative implementation. The curve 1602 represents the sinusoidal oscillation of a sense mass about a central anchor. The oscillation shown in FIG. 16 may be the oscillation of any one of the sense masses described herein. The horizontal axis of FIG. 16 represents time normalized by period of the sense mass, meaning that FIG. 16 represents a full period of oscillation of the sense mass. The sense mass shown in FIG. 16 has a resonant frequency of 2 kHz and thus a period of 500 μs.

FIG. 17 is a graph representing the velocity of a moveable element of an out-of-plane sensor relative to time, according to an illustrative implementation. The curve 1702 depicted in FIG. 17 represents velocity of the sinusoidal oscillation of a sense mass about a central anchor. The oscillation shown in FIG. 17 may be the oscillation of any one of the sense masses described herein. The curve 1702 is the first time derivative of the curve 1602 as shown in FIG. 16.

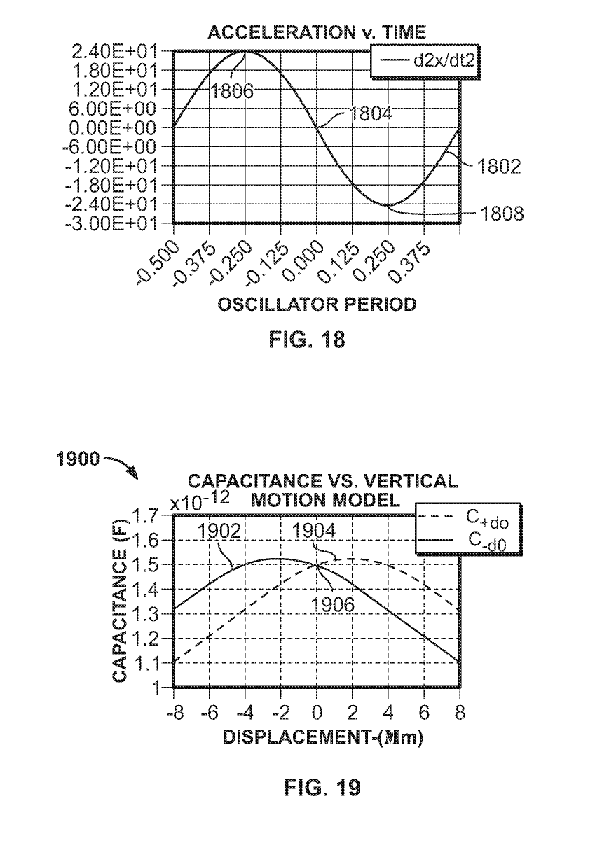

FIG. 18 is a graph representing acceleration of a moveable element of an out-of-plane sensor relative to time, according to an illustrative implementation. The curve 1802 represents acceleration of the sinusoidal oscillation of a sense mass about a central anchor. The oscillation shown in FIG. 18 may be the oscillation of any one of the sense masses described herein. The curve 1802 is the first time derivative of the curve 1702 as shown in FIG. 17, and the second time derivative of the curve 1602 as shown in FIG. 16.

FIGS. 16-18 show the relationship between the displacement of a sense mass as shown in FIG. 16 and the inertial parameters velocity and acceleration as shown in FIG. 17 and FIG. 18 respectively. The curves 1602, 1702 and 1802 may represent the oscillation of a sense mass in the absence of external perturbations other than the drive force produced by drive structures to actuate the sense mass. As can be seen, local extrema of one signal may translate to a zero-crossing in another.

FIG. 19 is a graph representing two capacitive signals produced by an out-of-plane sensor relative to the displacement of a moveable element of the out-of-plane sensor, according to an illustrative implementation. The output curve 1902 is offset from the output curve 1904, and has an intersection point at 1906. The output curves 1902 and 1904 are displaced from each other, such that they are identical signals that have a crossing point 1906. FIG. 19 illustrates the differential technique employed herein, where nonlinear signals 1902 and 1904 may be linearly combined to produce a differential signal such that crossing point 1906 becomes a zero-crossing of the differential signal. Alternatively, time intervals measured from signal 1902 between 1902's own zero-crossings may be used in addition to time intervals measured from 1904 between 1904's own zero-crossings to produce differential measurement of a parameter of interest, such as acceleration.

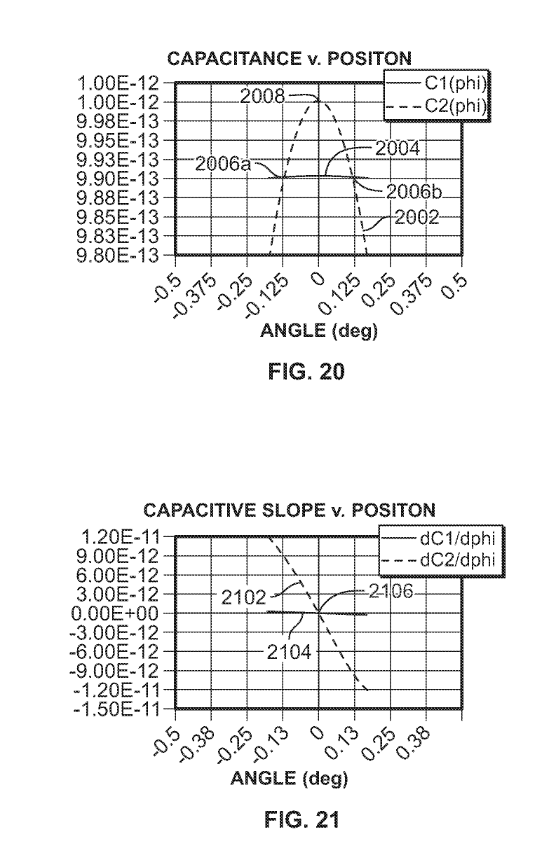

FIG. 20 is a graph representing capacitance relative to angular position of the moveable element of an out-of-plane sensor, according to an illustrative implementation. FIG. 20 represents changes in capacitance of a first and second electrode as a sense mass oscillates about a central anchor. FIG. 20 may represent an output signal produced by the electrodes 204a and 204b as depicted in FIG. 2. The signals 2002 and 2004 may be produced in response to the motion depicted in any of the moveable elements of the out-of-plane sensor described herein, for example in FIGS. 1-5. As shown in FIG. 2, because the electrode 204a located at the larger radius 212 experiences a larger change in position than the electrode 204b located at the smaller radius 210 for the same angular displacement, the electrode 204a experiences a larger change in capacitance as well. In some examples, the signal 2004 may be a constant value. In some examples, the signal 2004 may vary inversely to signal 2002, such that a maximum of signal 2002 corresponds to a minimum of signal 2004. In any of these cases, curve 2002 shows the change in capacitance of electrode 204a, while curve 2004 shows the change in capacitance of electrode 204b. At the angular positions 2008 and 2006, the capacitance of the two electrodes is equal. As depicted in FIG. 20, these angular positions are approximately +/−0.124°. The magnitudes of capacitance curves 2002 and 2006 may vary due to applied bias, rotational mass velocity, temperature, electronic drift, and other such factors, but the physical, angular positions at which the capacitances equal each other are defined by the geometry of the sense mass 208 and position of the electrodes 204a and 204b, and will therefore be invariant under any changes in these outside factors. Thus using differential signal processing, where the curve 2002 and 2004 may be linearly combined and subtracted from each other, the locations 2008 and 2006 will correspond to positions at which the differential in capacitance is equal to zero. As the sense mass oscillates, the differential capacitance can be measured and the times at which the sense mass passes these predetermined angular positions can therefore be determined.

FIG. 21 is a graph representing capacitive slope relative to angular position of a moveable element of an out-of-plane sensor, according to an illustrative implementation. The curves 2102 and 2104 represent changes in the capacitive slope of the capacitance produced by first and second electrodes as a sense mass oscillates about a central anchor. The electrodes may be the electrodes 204a and 204b as depicted with reference to FIG. 2. The curve 2102 may correspond to the capacitive slope of electrode 204a, while the curve 2104 may correspond to the capacitive slope of electrode 204b. The curve 2102 is the first spatial derivative of curve 2002, and the curve 2104 is the first spatial derivative of curve 2004 as depicted with reference to FIG. 20.

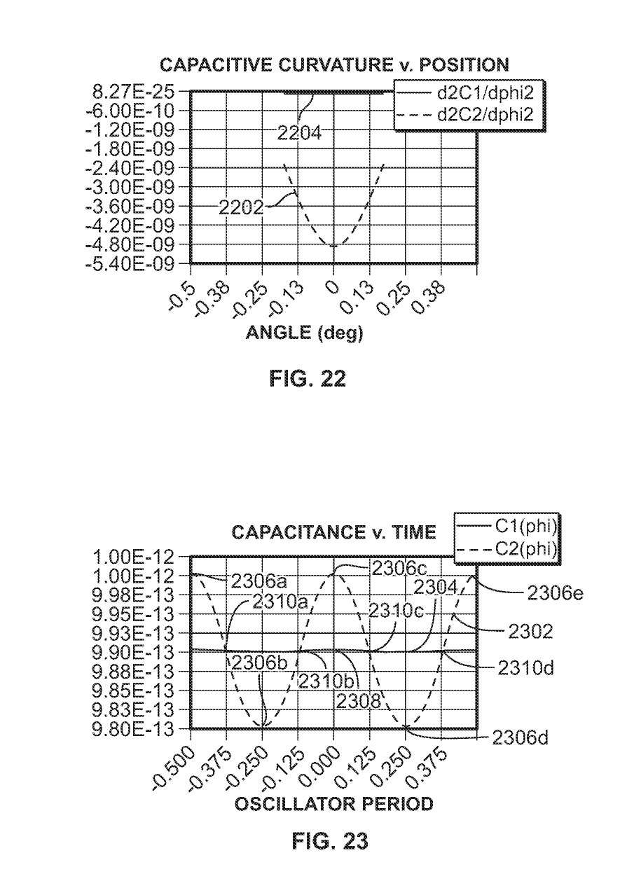

FIG. 22 is a graph representing capacitive curvature relative to angular position of a moveable element of an out-of-plane sensor, according to an illustrative implementation. The curves 2202 and 2204 represent changes in the capacitive curvature produced by first and second electrodes as a sense mass oscillates about a central anchor. The electrodes may be electrodes 204a and 204b as depicted with reference to FIG. 2. The curve 2202 may correspond to electrode 204a, while the curve 2204 may correspond to electrode 204b. The curve 2204 is the first spatial derivative of curve 2104, while the curve 2202 is the first spatial derivative of curve 2102 as depicted with reference to FIG. 21. The curve 2202 is the second spatial derivative of the curve 2002, while the curve 2204 is the second spatial derivative of curve 2004, as depicted in with reference to FIG. 20.

FIG. 23 is a graph representing capacitance relative to time and produced in response to oscillations of a moveable element of an out-of-plane sensor, according to an illustrative implementation. The curves 2302 and 2304 represent changes in the capacitive curvature produced by first and second electrodes as a sense mass oscillates about a central anchor. The electrodes may be electrodes 204a and 204b as depicted with reference to FIG. 2. The curve 2302 may be produced by the electrode 204a, while the curve 2304 may be produced by the electrode 204b. The capacitance can be measured by one or more capacitance-to-voltage (C-to-V) converters. A C-to-V converter can be a charge amplifier, a switch capacitor, a bridge with a general impedance converter (GIC), or another analog front end that produces a voltage corresponding to a measured charge or capacitance.

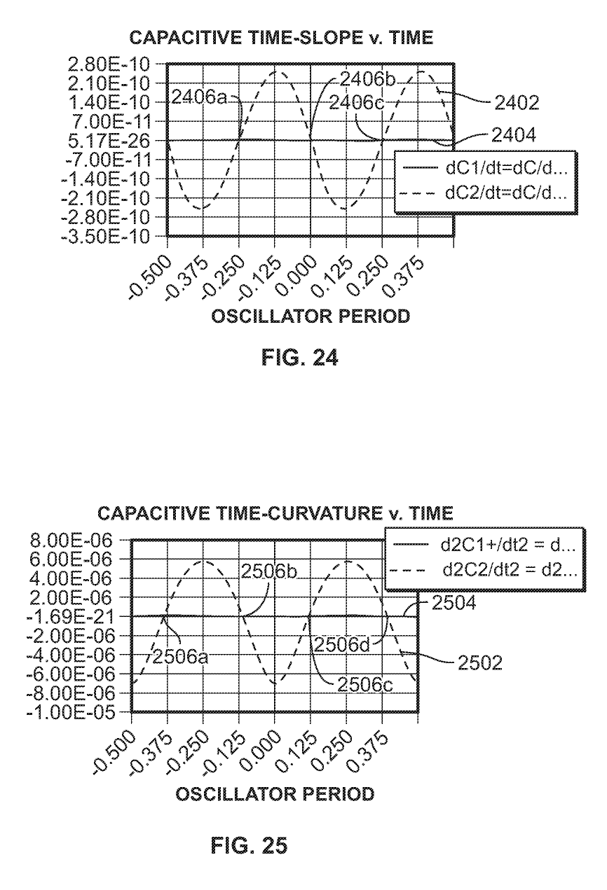

FIG. 24 is a graph representing capacitive slope relative to time and produced in response to oscillation of a moveable element of an out-of-plane sensor, according to an illustrative implementation. The curves 2402 and 2404 represent changes in the capacitive slope produced by first and second electrodes as a sense mass oscillates about a central anchor. The electrodes may be electrodes 204a and 204b as depicted with reference to FIG. 2. The curve 2402 may be produced by the electrode 204a, while the curve 2404 may be produced by the electrode 204b. The curve 2402 is the first time derivative of curve 2302, while the curve 2404 is the first time derivative of curve 2304 as shown in FIG. 23. The curves 2402 and 2404 can be measured by an analog front end that measures current, such as a transimpedance amplifier (TIA).

FIG. 25 is a graph representing capacitive curvature relative to time and produced in response to oscillations of a moveable element of an out-of-plane sensor, according to an illustrative implementation. The curves 2502 and 2504 represent changes in the capacitive curvature produced by first and second electrodes as a sense mass oscillates about a central anchor. The electrodes may be electrodes 204a and 204b as depicted with reference to FIG. 2. The curve 2502 may be produced by the electrode 204a, while the curve 2504 may be produced by the electrode 204b. The curve 2502 is the first time derivative of curve 2402, while the curve 2504 is the first time derivative of curve 2404 as shown in FIG. 24. As the second time derivatives, curves 2502 and 2504 represent the rates at which the capacitive slopes change.

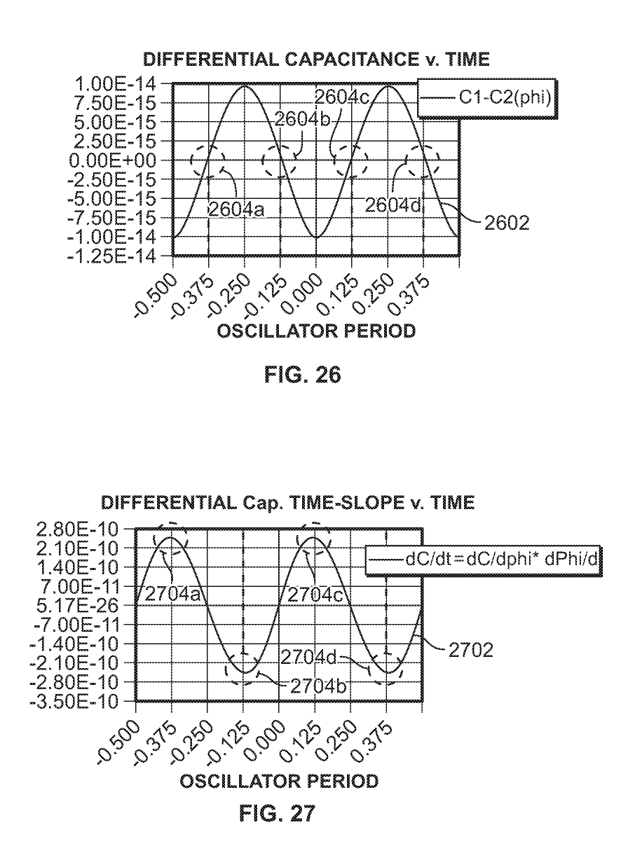

FIG. 26 is a graph representing differential capacitance relative to time and produced in response to oscillations of a moveable element of an out-of-plane sensor, according to an illustrative implementation. The curve 2602 is the difference of the curves 2302 and 2304 as shown with reference to FIG. 23. The curve 2602 can be obtained by measuring the difference of capacitance between the first and second electrodes. The electrodes may be electrodes 204a and 204b as depicted with reference to FIG. 2. This may be measured by a differential amplifier, or the capacitance curves 2302 and 2304 can be measured separately and the difference obtained via analog or digital signal processing. The time at which the curve 2602 equals zero are the zero-crossing times shown at 2604. These zero-crossing times are the times at which the capacitances of the first and second electrodes are equal. These zero-crossing times correspond to the predetermined angular positions at which the two electrodes have the same capacitance. The times shown at 2604 may be detected via analog means and can be converted to a digital signal by a time-to-digital converter (TDC) or an analog-to-digital converter (ADC). The digital signal produced by the TDC can be a binary signal that toggles between high and low signals when the zero-crossings 2604 are detected. The ADC may produce a digital output signal that is a digital representation of the differential capacitive signal 2602. The digital ADC output signal may contain noise as a result of the sampling rate of the ADC. To determine zero-crossing times and reduce sampling noise, linear, splined or polynomial interpolation may be performed near zero-crossing points or regions of zero capacitance. These interpolation techniques may determine times at which a portion of the ADC signal crosses a threshold (such as a zero) if the crossing occurs between two sample times of the ADC, and thus will reduce noise from the sampling rate of the ADC. In either case, by measuring the times at which zero-crossings 2604 occur, the time at which the sense mass is at a predetermined angular position may also be determined.

FIG. 27 is a graph representing differential capacitive slope relative to time and produced in response to oscillations of a moveable element of an out-of-plane sensor, according to an illustrative implementation. The curve 2702 represents changes in the slope of differential capacitance between a first and second electrode as a sense mass oscillates about a central anchor. The electrodes may be electrodes 204a and 204b as depicted with reference to FIG. 2. The curve 2702 can be obtained by a differential measurement of current from the first and second electrodes. Alternatively, the curve 2702 can be obtained by differentiating the curve 2602 as shown in FIG. 26 using digital signal processing. The extrema 2704 of the curve 2702 correspond to the zero-crossings of the curve 2602 as shown in FIG. 26. Thus, the zero-crossings 2704 can be measured by peak detection of the curve 2602. This peak detection can be performed via analog or digital means. Furthermore, the magnitude of the capacitive slope curve depicted in FIG. 27 corresponds to the steepness of the curve 2602. A steeper slope at zero-crossing times results in lower timing uncertainty of the zero-crossing time measurements.

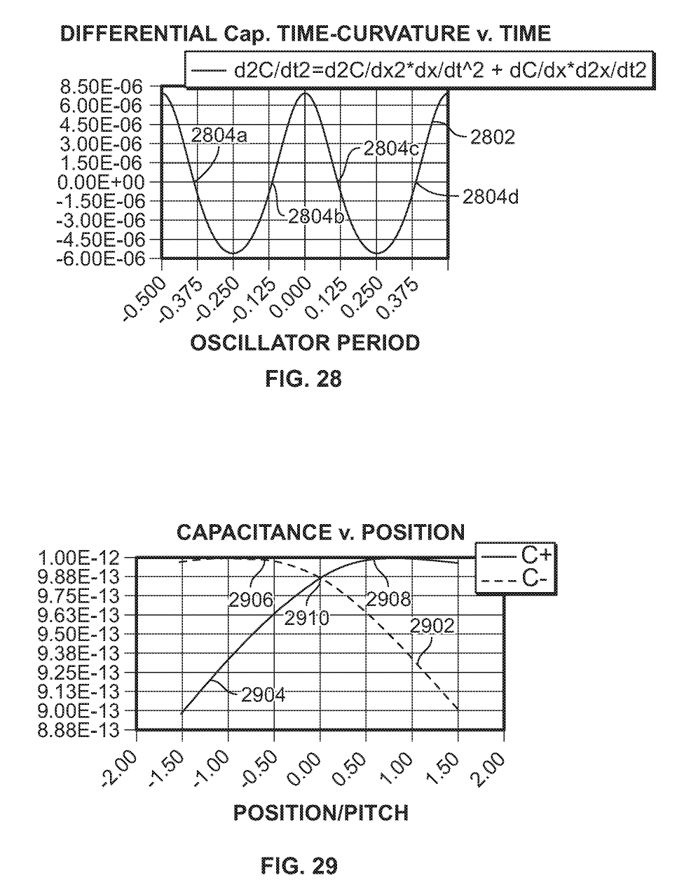

FIG. 28 is a graph representing differential capacitive curvature relative to time and produced in response to oscillations of a moveable element of an out-of-plane sensor, according to an illustrative implementation. The curve 2802 represents changes in curvature of differential capacitance between two electrodes as a sense mass oscillates about a central anchor. The electrodes may be electrodes 204a and 204b as depicted with reference to FIG. 2. The curve 2802 can be obtained by differentiating the curve 2702 as shown in FIG. 27 using analog or digital signal processing. The magnitude of the curvature curve 2802 represents the steepness of the slope of the curve 2702. A higher magnitude of curvature will result in lower timing uncertainty of peak detection measurements of the curve 2802.

FIG. 29 is a graph representing capacitance relative to the position of a moveable element of a second out-of-plane sensor, according to an illustrative implementation. FIG. 29 represents changes in capacitance of a first and second electrode as a sense mass oscillates about a central anchor. FIG. 29 may represent an output signal produced by the electrodes 306a and 306b as depicted in FIG. 3. The oscillation of the sense mass may entail raising and lowering in only the vertical direction as shown in FIG. 3. The signals 2902 and 2904 may be produced in response to the motion of a sense mass as shown in FIG. 3. Because the electrodes 306a and 306b have different heights (as shown at the gap 310 in FIG. 3) and are thus aligned with the stationary electrode comprising the sense mass 312 at different vertical positions, the capacitive curves 2902 and 2904 have local extrema 2906 and 2908 at different vertical positions. The local maximum of each curve corresponds to the vertical position at which the moving electrode positioned on the oscillating sense mass is aligned with the stationary electrode. The vertical position corresponding to the local maximum depends only on the geometry of the stationary electrodes and the moving sense mass. Thus, although the magnitude of capacitance may vary due to bias, sense mass velocity, temperature, electronic drift, or other factors, the vertical position in which the maximum of capacitance occurs for each electrode remains constant. By determining times at which these maxima 2906 and 2908 occur, the times at which the sense mass is in the corresponding vertical position may be determined.

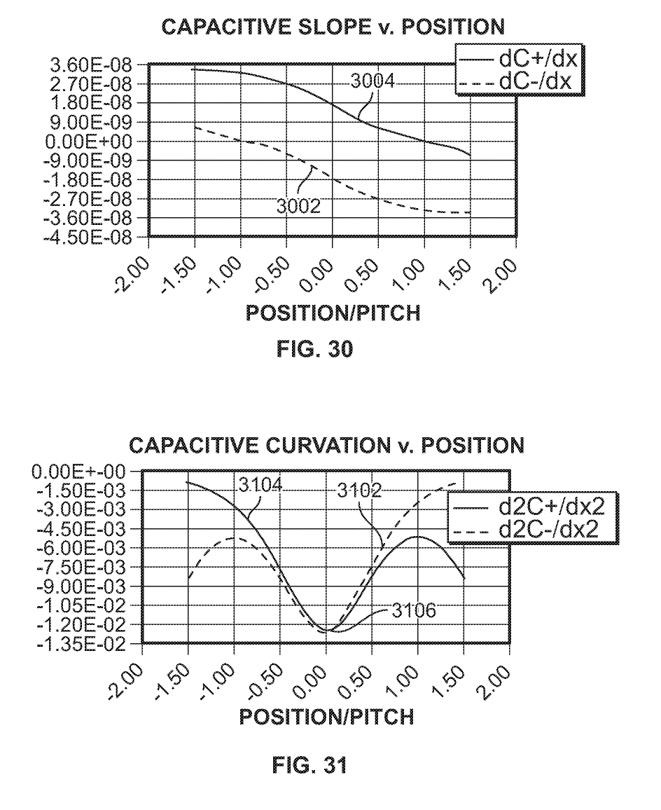

FIG. 30 is a graph representing capacitive slope relative to the position of a moveable element of a second out-of-plane sensor, according to an illustrative implementation. The curves 3004 and 3002 represent changes in the capacitive slope of the first and second electrodes as the sense mass oscillates about a central anchor. The electrodes may be 306a and 306b as shown in FIG. 3. The curve 3004 may be the first spatial derivative of the curve 2904, while the curve 3002 may be the first spatial derivative of curve 2902, as shown in FIG. 29.

FIG. 31 is a graph representing capacitive curvature relative to the position of a moveable element of a second out-of-plane sensor, according to an illustrative implementation. The curves 3102 and 3104 represent changes in the capacitive curvature of the first and second electrodes as the sense mass oscillates about a central anchor. The electrodes may be 306a and 306b as shown in FIG. 3. The curve 3102 may be the first spatial derivative of curve 3002, while the curve 3104 may be the first spatial derivative of curve 3004, as shown in FIG. 30.

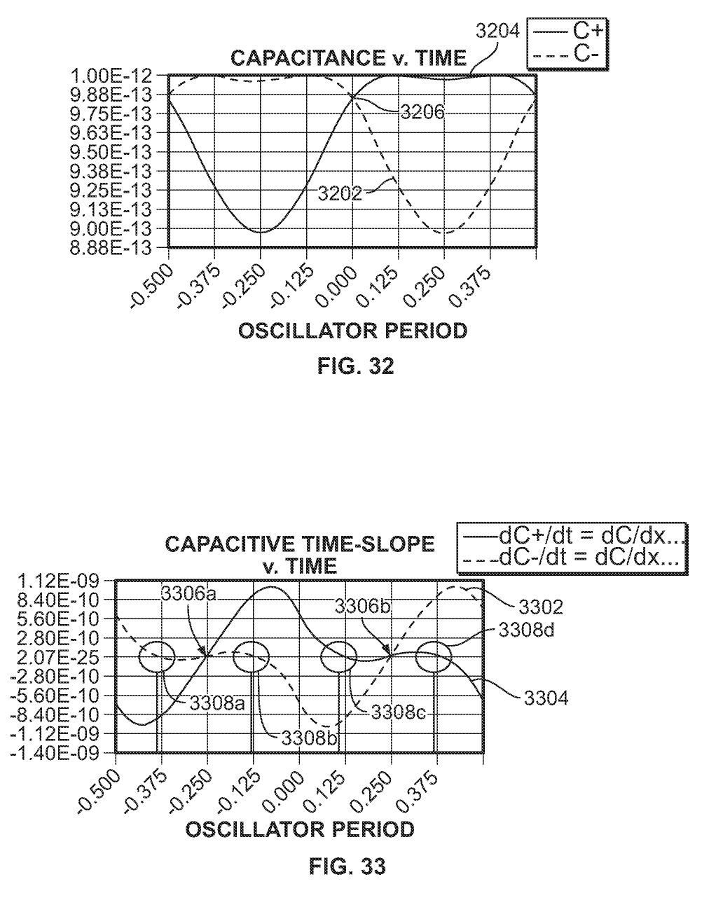

FIG. 32 is a graph representing capacitance relative to time and produced in response to oscillations of a moveable element of an second out-of-plane sensor, according to an illustrative implementation. The curves 3202 and 3204 represent changes in capacitance of the first electrode and the second electrode as a sense mass oscillates about a central anchor. The electrodes may be 306a and 306b as shown in FIG. 3. The times at which the capacitance experiences a local extremum correspond to either times of zero velocity or times at which the moving sense mass is aligned with the stationary electrode, causing a local maximum in capacitance.

FIG. 33 is a graph representing capacitive slope relative to time and produced in response to oscillations of a moveable element of a second out-of-plane sensor, according to an illustrative implementation. The curves 3302 and 3304 represent changes in capacitance of the first electrode and the second electrode as a sense mass oscillates about a central anchor. The electrodes may be 306a and 306b as shown in FIG. 3. The curve 3302 is the first time derivative of curve 3202, while the curve 3304 is the first time derivative of curve 3204, as shown in FIG. 32. Thus the curves 3302 and 3304 represent the rates at which capacitance changes. The capacitive slopes 3302 and 3304 can be measured by an analog front end, such as a TIA, that measures current. The times at which the capacitive slope is equal to zero correspond to times at which the capacitance is at a local extremum or inflection point. These times may correspond to times at which a sense mass is at zero velocity, or times at which the sense mass is aligned with the stationary electrode, causing a local maximum in capacitance. By determining times at which the capacitive slope crosses zero (or zero-crossing times), the corresponding times at which the sense mass is at a predetermined position with respect to the stationary electrode can be determined.

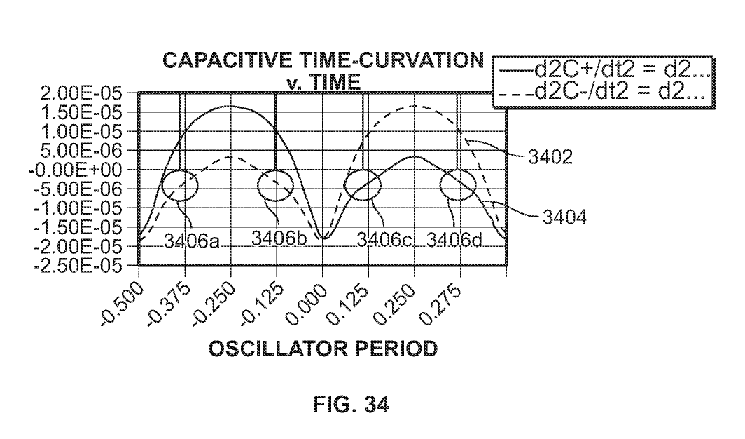

FIG. 34 is a graph representing capacitive curvature relative to time and produced in response to oscillations of a moveable element of a second out-of-plane sensor, according to an illustrative implementation. The curves 3402 and 3404 represent changes in the capacitive curvature of the first and second electrodes as a sense mass oscillates about a central anchor. The curve 3402 is the first time derivative of the curve 3302, while the curve 3404 is the first time derivative of the curve 3304, as shown in FIG. 33.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, flash memory (e.g., AND/NOR, NAND), memrister memory, and PSRAM.

As used herein, the term “processor” is meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, secure microprocessors, and ASICs). Such digital processors may be contained on a single unitary integrated circuit die, or distributed across multiple components.

From the above description of the system it is manifest that various techniques may be used for implementing the concepts of the system without departing from its scope. In some examples, any of the circuits described herein may be implemented as a printed circuit with no moving parts. Further, various features of the system may be implemented as software routines or instructions to be executed on a processing device (e.g. a general purpose processor, an ASIC, an FPGA, etc.) The described embodiments are to be considered in all respects as illustrative and not restrictive. It should also be understood that the system is not limited to the particular examples described herein, but can be implemented in other examples without departing from the scope of the claims.

Similarly, while operations are depicted in the drawings in a particular order, this should not be understood as requiring that such operations be performed in the particular order shown or in sequential order, or that all illustrated operations be performed, to achieve desirable results.

What is claimed is:

1. An out-of-plane sensor, comprising:
a sense mass coupled to an in-plane support structure; the sense mass configured to oscillate out-of-plane with respect to the in-plane support structure;
a time domain switch coupled to the sense mass, comprising:
a first electrode at a first radial distance of the sense mass and producing a first signal; and
a second electrode at a second radial distance of the sense mass and producing a second signal; and
a processor in signal communication with the time domain switch and configured to detect time intervals from a linear combination of the first signal and the second signal.

2. The out-of-plane sensor of claim 1, wherein the sense mass oscillates out-of-plane in rotation about an axis in a plane of the in-plane support structure.

3. The out-of-plane sensor of claim 2, wherein:
the first radial distance is larger than the second radial distance;
the first electrode has a first area; and
the second electrode has a second area, wherein the first area is larger than the second area.

4. The out-of-plane sensor of claim 3, wherein the linear combination of the first signal and the second signal is a differential in capacitance.

5. The out-of-plane sensor of claim 4, wherein the time intervals are based in part on times at which the differential in capacitance is equal to zero.

6. The out-of-plane sensor of claim 5, further comprising determining an acceleration of the in-plane support structure based on the time intervals.

7. The out-of-plane sensor of claim 1, wherein the first electrode is vertically offset upward from the sense mass.

8. The out-of-plane sensor of claim 7, wherein the second electrode is vertically offset downward from the sense mass.

9. The out-of-plane sensor of claim 8, wherein a portion of the sense mass and the second electrode are etched to the same height.

10. The out-of-plane sensor of claim 8, wherein the sense mass oscillates by raising and lowering linearly along an axis perpendicular to the in-plane support structure.

11. The out-of-plane sensor of claim 10, wherein the first radial distance is larger than the second radial distance, and wherein the area of the first electrode is equal to the area of the second electrode.

12. The out-of-plane sensor of claim 11, wherein the time intervals are a first set of time intervals based on zero-crossings of a time derivative the first signal, and a second set of time intervals based on zero-crossings of a time derivative of the second signal.

13. The out-of-plane sensor of claim 12, wherein the time intervals of the first set and the second set do not include points of zero velocity.

14. The out-of-plane sensor of claim 13, further comprising determining an acceleration of the in-plane support structure based on the time intervals.

15. A system for out-of-plane sensing, comprising:
a sense mass coupled to an in-plane support structure, the sense mass configured to oscillate out-of-plane with respect to the in-plane support structure;
a time domain switch coupled to the sense mass, comprising:
a first electrode at a first radial distance of the sense mass and producing a first signal; and
a second electrode at a second radial distance of the sense mass and producing a second signal; and
a processor in signal communication with the time domain switch and configured to detect time intervals from a linear combination of the first signal and the second signal.

16. The system of claim 15, wherein the sense mass oscillates out-of-plane in rotation about an axis in a plane of the in-plane support structure.

17. The system of claim 16, wherein:
the first radial distance is larger than the second radial distance;
the first electrode has a first area; and
the second electrode has a second area, wherein the first area is larger than the second area.

18. The system of claim 17, wherein the linear combination of the first signal and the second signal is a differential in capacitance.

19. The system of claim 18, wherein the time intervals are based in part on times at which the differential in capacitance is equal to zero.

20. The system of claim 19, further comprising determining an acceleration of the in-plane support structure based on the time intervals.

21. The out-of-plane sensor of claim 15, wherein first electrode is vertically offset upward from the sense mass.

22. The out-of-plane sensor of claim 20, wherein the second electrode is vertically offset downward from the sense mass.

23. The out-of-plane sensor of claim 22, wherein a portion of the sense mass and the second electrode are etched to the same height.

24. The system of claim 23, wherein the sense mass oscillates by raising and lowering linearly along an axis perpendicular to the in-plane support structure.

25. The system of claim 24, wherein the first radial distance is larger than the second radial distance, and wherein the area of the first electrode is equal to the area of the second electrode.

26. The system of claim 25, wherein the time intervals are a first set of time intervals based on zero-crossings of a time derivative of the first signal, and a second set of time intervals based on zero-crossings of a time derivative of the second signal.

27. The system of claim 26, wherein the time intervals of the first set and the second set do not include points of zero velocity.

28. The system of claim 26, further comprising determining an acceleration of the in-plane support structure based on the time intervals.
